(19) United States
(12) Patent Application Publication
(10) Pub. No.: US 2023/0089031 A1
(43) Pub. Date: Mar. 23, 2023

(54) IMAGING LENS SYSTEM

(71) Applicant: SAMSUNG ELECTRO-MECHANICS CO., LTD., Suwon-si (KR)

(72) Inventors: Jae Hyuk HUH, Suwon-si (KR); Byung Hyun KIM, Suwon-si (KR); So Mi YANG, Suwon-si (KR)

(73) Assignee: SAMSUNG ELECTRO-MECHANICS CO., LTD., Suwon-si (KR)

(21) Appl. No.: 17/863,800

(22) Filed: Jul. 13, 2022

(30) Foreign Application Priority Data
Sep. 16, 2021 (KR) 10-2021-0124130
Apr. 14, 2022 (KR) 10-2022-0046244

(51) Int. Cl. G02B 13/00; G02B 9/02; G02B 9/04

(52) U.S. Cl. CPC G02B 13/0065; G02B 9/02; G02B 9/04; G02B 13/003; G02B 13/0025

(57) ABSTRACT

An imaging lens system includes a first lens group, a first reflective portion including a plurality of reflective surfaces, and a second reflective portion including a plurality of reflective surfaces. The first lens group, the first reflective portion, and the second reflective portion are sequentially arranged from an object side, and 2.0 < TTL/f1 < 4.0 is satisfied, where TTL is a distance from an object-side surface of a first lens of the first lens group to an imaging plane, and f1 is a focal length of the first lens.

### CROSS-REFERENCE TO RELATED APPLICATION(S

This application claims the benefit under 35 USC 119(a) of Korean Patent Application Nos. 10-2021-0124130 filed on Sep. 16, 2021 and 10-2022-0046244 filed on Apr. 14, 2022 in the Korean Intellectual Property Office, the entire disclosures of which are incorporated herein by reference for all purposes.

### BACKGROUND

### 1. Field

The present disclosure relates to an imaging lens system having a long focal length.

### 2. Description of Related Art

An imaging lens system having a long focal length (e.g., a telephoto imaging lens system) is not easy to reduce in thickness and size, and thus it is difficult to mount such an imaging lens system in a small terminal. However, as demand for functional improvement and performance improvement of small terminals, i.e., smartphones, increases, the need to mount a telephoto imaging lens system in small terminals has increased.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens group, a first reflective portion including a plurality of reflective surfaces, and a second reflective portion including a plurality of reflective surfaces. The first lens group, the first reflective portion, and the second reflective portion are sequentially arranged from an object side, and 2.0 < TTL/f1 < 4.0 is satisfied, where TTL is a distance from an object-side surface of a first lens of the first lens group to an imaging plane, and f1 is a focal length of the first lens.

The first reflective portion may further include a first rearmost reflective surface disposed closest to the second reflective portion, and a first reflective surface configured to re-reflect light reflected from the first rearmost reflective surface to the second reflective portion.

The first reflective portion may further include a first frontmost reflective surface configured to reflect light exiting the first lens group to the first rearmost reflective surface.

The second reflective portion may further include a second frontmost reflective surface disposed closest to the first reflective portion, and a second reflective surface configured to reflect light irradiated from the first reflective surface to the second frontmost reflective surface.

The second reflective portion may further include a second rearmost reflective surface configured to reflect light irradiated from the second frontmost reflective surface to the imaging plane.

An included angle between the first rearmost reflective surface and the first reflective surface may be equal to an included angle between the second frontmost reflective surface and the second reflective surface.

The first lens group may have positive refractive power.

The imaging lens system may further include a third reflective portion disposed on an object side of the first reflective portion.

The imaging lens system may further include a second lens group disposed between the third reflective portion and the first reflective portion.

In another general aspect, an imaging lens system includes a lens group, a first reflective portion including a plurality of reflective surfaces and a second reflective portion including a plurality of reflective surfaces. The first lens group, the first reflective portion, and the second reflective portion are sequentially arranged from an object side, and the first reflective portion and the second reflective portion each include a total reflection surface.

The lens group may include a first lens having positive refractive power, and a second lens having negative refractive power.

The imaging lens system, wherein 30 < V1-V2 may be satisfied, where V1 is an Abbe number of the first lens, and V2 is the Abbe number of the second lens.

The imaging lens system, wherein 2.0 < TTL/f1 < 4.0 may be satisfied, where TTL is a distance from an object-side surface of the first lens to an imaging plane, and f1 is a focal length of the first lens.

The imaging lens system, wherein -5.0 < TTL/f2 < -0.2 may be satisfied, where TTL is a distance from an object-side surface of the first lens to an imaging plane, and f2 is a focal length of the second lens.

The imaging lens system, wherein 1.1 < TTL/f may be satisfied, where TTL is a distance from an object-side surface of a frontmost lens of the lens group to an imaging plane, and f is a focal length of the imaging lens system.

The imaging lens system, wherein 0.6 < BFL/TTL < 0.9 may be satisfied, where BFL is a distance from an image-side surface of a rearmost lens of the lens group to an imaging plane, and TTL is a distance from an object-side surface of a frontmost lens of the lens group to an imaging plane.

Other features and aspects will be apparent from the following detailed description, the drawings, and the claims.

### BRIEF DESCRIPTION OF DRAWINGS

FIG. 1 is a block diagram of an imaging lens system according to a first embodiment.

FIG. 2 is an aberration curve of the imaging lens system illustrated in FIG. 1.

FIG. 3 is a first example embodiment of the imaging lens system illustrated in FIG. 1.

FIG. 4 is a second example embodiment of the imaging lens system illustrated in FIG. 1.

FIG. 5 is a third example embodiment of the imaging lens system illustrated in FIG. 1.

FIG. 6 is a fourth example embodiment of the imaging lens system illustrated in FIG. 1.

FIG. 7 is a fifth example embodiment of the imaging lens system illustrated in FIG. 1.

FIG. 8 is a block diagram of an imaging lens system according to a second embodiment.

FIG. 9 is an aberration curve of the imaging lens system illustrated in FIG. 8.

FIG. 10 is an example embodiment of the imaging lens system illustrated in FIG. 8.

FIG. 11 is a block diagram of an imaging lens system according to a third embodiment.

FIG. 12 is an aberration curve of the imaging lens system illustrated in FIG. 11.

FIG. 13 is a first example embodiment of the imaging lens system illustrated in FIG. 11.

FIG. 14 is a second example embodiment of the imaging lens system illustrated in FIG. 11.

FIG. 15 is a block diagram of an imaging lens system according to a fourth embodiment;

FIG. 16 is an aberration curve of the imaging lens system illustrated in FIG. 15.

FIG. 17 is a block diagram of an imaging lens system according to a fifth embodiment.

FIG. 18 is an aberration curve of the imaging lens system illustrated in FIG. 17.

FIG. 19 is a block diagram of an imaging lens system according to a sixth embodiment.

FIG. 20 is an aberration curve of the imaging lens system illustrated in FIG. 19.

FIG. 21 is a block diagram of an imaging lens system according to a seventh embodiment.

FIG. 22 is an aberration curve of the imaging lens system illustrated in FIG. 21.

FIG. 23 is a block diagram of an imaging lens system according to an eighth embodiment.

FIG. 24 is an aberration curve of the imaging lens system illustrated in FIG. 23.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

In the present disclosure, a first lens refers to a lens closest to an object (or a subject). In addition, the number of lenses refers to the order in which the lenses are arranged in an optical axis direction from the object side. For example, a second lens refers to a lens positioned second from the object side, and a third lens refers to a lens positioned third from the object side. In the present disclosure, units of a radius of curvature, thickness, TTL (a distance from the object side of the first lens to an imaging plane), 2lmgHT (a diagonal length of the imaging plane), ImgHT (a height of the imaging plane or ½ of 2lmgHT), and a focal length are mm.

The thickness of the lenses, the distance between the lenses, the TTL, and an incident angle are calculated sizes based on the optical axis of the imaging lens system. In addition, in the description of the shape of the lens, a convex shape of one surface means that a paraxial region of a corresponding surface is convex, and a concave shape of one surface means that a paraxial region of a corresponding surface is concave. Accordingly, even if one surface of the lens is described as having a convex shape, an edge portion of the lens may be concave. Similarly, even if one surface of the lens is described as having a concave shape, an edge portion of the lens may be convex.

The imaging lens system described herein may be configured to be mounted on a portable electronic device. For example, the optical imaging system may be mounted on a smartphone, a notebook computer, an augmented reality device, a virtual reality device (VR), a portable game machine, or the like. However, the range and examples of use of the imaging lens system described in the present disclosure are not limited to the electronic devices described above. For example, the optical imaging system may be applied to an electronic device providing a narrow mounting space but requiring high-resolution imaging.

The optical imaging system described herein may be configured to reduce the external size of the optical imaging system, while securing a long back focal length (BFL) (a distance from an image-side surface of the rearmost lens to the imaging plane). For example, the optical imaging system may reduce the external size of the optical imaging system, while securing the BFL desired to realize the telephoto imaging lens system through a reflective portion.

According to the present disclosure, the imaging lens system may include a lens. In detail, the optical imaging system may include one or more lenses sequentially arranged along the optical axis. For example, the imaging lens system may include a first lens, a second lens, and a third lens sequentially arranged from an object side. However, the number of lenses constituting the imaging lens system is not limited to three. For example, the imaging lens system may include less than 3 lenses or 4 or more lenses.

The imaging lens system may be configured to form a long optical path in a limited space. For example, according to the present disclosure, the reflective portion may be configured to reflect light twice or more.

According to the present disclosure, the optical imaging system may include a plurality of reflective portions. For example, the imaging lens system may include a first and second reflective portion between the rearmost lens and the imaging plane. The first reflective portion and the second reflective portion may be sequentially disposed along the optical path.

According to the present disclosure, the first and second reflective portions may be configured to transmit and reflect light. For example, the first reflective portion may be configured to reflect incident light three or more times and then refract light to the second reflective portion, and the second reflective portion may be configured to reflect incident light two or more times and then irradiate light to the imaging plane.

According to the present disclosure, the first and second reflective portions may be configured to have a predetermined correlation. For example, a projection surface of the first reflective portion may be configured to be parallel to an incident surface of the second reflective portion. As another example, a final reflective surface of the first reflective portion and a projection surface of the second reflective portion may be configured to be parallel or orthogonal. As another example, an angle formed between the projection surface of the first reflective portion and a third reflective surface adjacent to the projection surface may be the same size as an angle formed between the incidence surface of the second reflective portion and a first reflective surface adjacent to the incident surface.

For reference, the reflective portion may be expressed in other terms in the present disclosure. For example, the reflective portion may be expressed as an optical path-changing unit or a prism.

According to a first aspect, an imaging lens system may include a first lens group, a first optical path-changing unit, and a second optical path-changing unit sequentially arranged from an object side. The first optical path-changing unit and the second optical path-changing unit may include a plurality of reflective surfaces. For example, the first optical path-changing unit may include two reflective surfaces, and the second optical path-changing unit may include two reflective surfaces. However, the number of reflective surfaces constituting the first optical path-changing unit and the second optical path-changing unit is not limited to two, respectively. For example, the first optical path-changing unit may include three reflective surfaces, and the second optical path-changing unit may include two reflective surfaces. As another example, the first optical path-changing unit may include two reflective surfaces, and the second optical path-changing unit may include three reflective surfaces.

According to the first aspect, the imaging lens system may be configured to satisfy a predetermined conditional expression. For example, the imaging lens system, according to the first aspect, may satisfy a conditional expression of 2.0 < TTL/f1 < 4.0 for a TTL (a distance from an object-side surface of the frontmost lens (i.e., a first lens) of the first lens group to an imaging plane) and a focal length f1 of the frontmost lens.

In the first aspect, the first optical path-changing unit may include two reflective surfaces as described above. As a specific example, the first optical path-changing unit may include a first rearmost reflective surface disposed to be closest to the second optical path-changing unit and a first reflective surface configured to reflect light reflected from the first rearmost reflective surface to the second optical path-changing unit. The first rearmost reflective surface and the first reflective surface may be disposed to be adjacent to each other in the first optical path-changing unit, and may have an included angle having a predetermined size therebetween. For example, a first included angle between the first rearmost reflective surface and the first reflective surface may be less than 45 degrees.

In the first aspect, the first optical path-changing unit may include three reflective surfaces. For example, the first optical path-changing unit may further include a first frontmost reflective surface in addition to the first rearmost reflective surface and the first reflective surface. The first frontmost reflective surface may be configured to reflect light exiting the first lens group to the first rearmost reflective surface.

In the first aspect, the second optical path-changing unit may include two or more reflective surfaces as described above. As a specific example, the second optical path-changing unit may include a second frontmost reflective surface closest to the first optical path-changing unit and a second reflective surface configured to reflect light irradiated from the first optical path-changing unit (specifically, the first reflective surface) to the second frontmost reflective surface. The second frontmost reflective surface and the second reflective surface may be disposed to be adjacent to each other in the second optical path-changing unit, and may have an included angle having a predetermined size therebetween. For example, the second included angle between the second frontmost reflective surface and the second reflective surface may be less than 45 degrees. As another example, the second included angle may be substantially the same as the first included angle.

In the first aspect, the second optical path-changing unit may include three reflective surfaces. For example, the second optical path-changing unit may further include a second rearmost reflective surface in addition to the second frontmost reflective surface and the second reflective surface. The second rearmost reflective surface may be configured to reflect light emitted from the second frontmost reflective surface to the imaging plane.

According to a second aspect, an imaging lens system may include a lens group, a first optical path-changing unit, and a second optical path-changing unit sequentially arranged from the object side. The first optical path-changing unit and the second optical path-changing unit may include a total reflective surface. For example, the first optical path-changing unit may include one total reflective surface, and the second optical path-changing unit may include one total reflective surface.

An imaging lens system according to a third aspect may further include a unique lens configuration in the imaging lens system according to the first or second aspect. For example, according to the third aspect of the imaging lens system, the first lens group may include a first lens with positive refractive power. As another example, the first lens group may include a first lens with positive refractive power and a second lens with negative refractive power.

According to a fourth aspect, an imaging lens system may include a first lens group, a first optical path-changing unit, a second lens group, a second optical path-changing unit, and a third optical path-changing unit, sequentially arranged from an object side. According to the fourth aspect, the imaging lens system may include the characteristics of the imaging lens systems according to the first to third aspects described above. For example, the second optical path-changing unit and the third optical path-changing unit of the fourth aspect may be configured to be the same as or similar to the first optical path-changing unit and the second optical path-changing unit according to the first and second aspects. As another example, the first lens group may be configured to be the same or similar to the first lens group according to the third aspect.

According to a fifth aspect, an imaging lens system may be configured to satisfy one or more of the following conditional expressions. However, only the imaging lens system according to the fifth aspect does not satisfy the following conditional expression. For example, according to the first to fourth aspects, the imaging lens systems may satisfy one or more of the following conditional expressions:
BFL/TTL < 0.9;
30 < V1-V2;
18 mm < f;
24 mm < TTL; and
1.1 < TTL/f.

In the above conditional expressions, BFL is a distance from an image-side surface of the rearmost lens of the lens group to an imaging plane, TTL is a distance from an object-side surface of the frontmost lens (first lens) of the lens group to the imaging plane, V1 is the Abbe number of the first lens, V2 is the Abbe number of the second lens (i.e., the lens disposed closest to the image side of the first lens), and f is a focal length of the imaging lens system.

According to the fifth aspect, the imaging lens system may be configured to further satisfy one or more of the following conditional expressions:
0.6 < BFL/TTL < 0.9;
32 < V1-V2 < 38;
18 mm < f < 36 mm;
24 mm < TTL < 42 mm;
1.1 < TTL/f < 1.4;
2.0 < TTL/f1 < 4.0;
-5.0 < TTL/f2 < -0.2;
–1.0 < TTL/f3 < 2.0;
2.6 < f number < 4.0;
2.0 < (fnumber)*f/TTL < 3.4;
0.16 < Vh1/TTL < 0.32; and
0.10 < Vh2/TTL < 0.23.

In the above conditional expression, f1 is a focal length of the first lens, f2 is a focal length of the second lens, f3 is a focal length of the third lens, Vh1 is a distance from an object-side surface of the first lens to the first reflective surface of the optical path-changing unit (based on the optical axis), and Vh2 is a distance from an object-side surface of the second lens to the first reflective surface of the optical path-changing unit (based on the optical axis).

Hereinafter, an embodiment in the present disclosure will be described in detail based on the accompanying drawings.

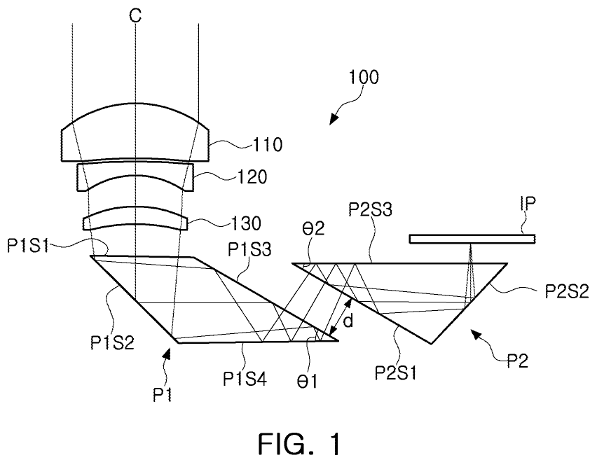

First, an imaging lens system according to a first embodiment will be described with reference to FIG. 1.

The imaging lens system 100, according to the present embodiment, includes a lens group including a first lens 110, a second lens 120, a third lens 130, a first reflective portion P1, and a second reflective portion P2. However, the configuration of the imaging lens system 100 is not limited to the aforementioned members. For example, the optical imaging system 100 may further include one or more lenses.

The first lens 110 to the third lens 130 may be sequentially disposed from the object side. For example, the second lens 120 may be disposed on the image side of the first lens 110, and the third lens 130 may be disposed on the image side of the second lens 120. The first lens 110 to the third lens 130 may be disposed at a predetermined interval. For example, the image-side surface of the first lens 110 may not be in contact with an object-side surface of the second lens 120, and the image-side surface of the second lens 120 may not be in contact with an object-side surface of the third lens 130. However, the first lens 110 to the third lens 130 are not necessarily disposed in a non-contact state. For example, the image-side surface of the first lens 110 may be disposed to be in contact with the object-side surface of the second lens 120, or the image-side surface of the second lens 120 may be disposed to be in contact with the object-side surface of the third lens 130.

Next, the characteristics of the first lens 110 to the third lens 130 will be described.

The first lens 110 has refractive power. For example, the first lens 110 may have positive refractive power. One surface of the first lens 110 may have a convex shape. For example, the first lens 110 may have a convex object-side surface. The first lens 110 may have a concave image-side surface. However, the image-side surface of the first lens 110 is not limited to a concave shape. For example, if desired, the first lens 110 may have a convex image-side surface. The first lens 110 may include a spherical surface. For example, both the object-side surface and the image-side surface of the first lens 110 may be formed of a spherical surface.

The second lens 120 has refractive power. For example, the second lens 120 may have negative refractive power. One surface of the second lens 120 may have a convex shape. For example, the second lens 120 may have a convex object-side surface. However, the object-side surface of the second lens 120 is not limited to a convex shape. For example, if desired, the second lens 120 may have a concave object-side surface. One surface of the second lens 120 may have a concave shape. For example, the second lens 120 may have a concave object-side surface. The second lens 120 may include an aspherical surface. For example, at least one of the object-side surface and the image-side surface of the second lens 120 may be formed as an aspherical surface.

The third lens 130 has refractive power. For example, the third lens 130 may have positive or negative refractive power. The third lens 130 may have a convex shape. For example, the third lens 130 may have a convex object-side surface. One surface of the third lens 130 may have a concave shape. For example, the third lens 130 may have a concave image-side surface. However, the image-side surface of the third lens 130 is not limited to a concave shape. For example, if desired, the third lens 130 may have a convex image-side surface. The third lens 130 may include an aspherical surface. For example, at least one of the object-side surface and the image-side surface of the third lens 130 may be formed as an aspherical surface.

The first reflective portion P1 and the second reflective portion P2 may be disposed between the third lens 130 and the imaging plane IP. The first reflective portion P1 and the second reflective portion P2 may be configured to reduce an external distance from the image-side surface of the third lens 130 to the imaging plane IP. In detail, the first reflective portion P1 and the second reflective portion P2 may reduce an external distance or size from the image-side surface of the third lens 130 to the imaging plane, without substantially changing an optical path length (or BFL) from the image-side surface of the third lens 130 to the imaging plane. Therefore, the optical imaging system 100, according to the present embodiment, may be mounted on a relatively small or thin terminal as it is optically designed. The first reflective portion P1 and the second reflective portion P2 may be configured in a prism shape. However, the shapes of the first reflective portion P1 and the second reflective portion P2 are not limited to the prism.

Next, the shapes of the first reflective portion P1 and the second reflective portion P2 will be described.

The first reflective portion P1 may be generally formed of a polyhedron. For example, the first reflective portion P1 may be formed to have a hexahedral shape. However, the shape of the first reflective portion P1 is not limited to a hexahedron. The cross-sectional shape of the first reflective portion P1 parallel to the optical axis C (or a cross-sectional shape of the first reflective portion P1 in which the optical path is formed) may be substantially quadrangular. For example, the cross-section of the first reflective portion P1 may have a trapezoidal shape in which a pair of opposite sides are parallel.

The cross-section of the first reflective portion P1 may be configured in a quadrangular shape with four sides, as illustrated in FIG. 1. For example, the cross-section of the first reflective portion P1 may include a first side P1S1, a second side P1S2, a third side P1S3, and a fourth side P1S4. However, the cross-section of the first reflective portion P1 is not necessarily quadrangular.

The first reflective portion P1 is configured to refract light incident from the third lens 130 to the second reflective portion P2. To this end, the first reflective portion P1 may include a plurality of reflective surfaces and a plurality of transmissive surfaces. In detail, the first reflective portion P1 may include three reflective surfaces and two transmissive surfaces.

The first reflective portion P1 may include a plurality of transmissive surfaces. For example, the first side P1S1 and the third side P1S3 of the first reflective portion P1 may form a first transmissive surface and a second transmissive surface, respectively. In detail, in the cross-sectional shape of the first reflective portion P1, the first side P1S1 closest to the third lens 130 forms a first transmissive surface, and in the cross-sectional shape of the first reflective portion P1, the third side P1S3 closest to the second reflective portion P2 may form a second transmissive surface.

The first reflective portion P1 may include a plurality of reflective surfaces. For example, the second side P1S2, the third side P1S3, and the fourth side P1S4 of the first reflective portion P1 may form a first reflective surface (or a first frontmost reflective surface), a second reflective surface (or a first rearmost reflective surface), and a third reflective surface (or a first reflective surface), respectively. In detail, the second side P1S2 may form a first reflective surface reflecting light incident through the first side P1S1, the third side P1S3 facing the second side P1S2 forms a second reflective surface reflecting light reflected from the second side P1S2 to the fourth side P1S4, and the fourth side P1S4 formed parallel to the first side P1S1 may form a third reflective surface re-reflecting light totally reflected from the third side P1S3 toward the third side P1S3.

That is, in the first reflective portion P1, according to the present embodiment, the first side P1S1 may form a first transmissive surface, the second side P1S2 may form a first reflective surface, the third side P1S3 may form a second transmissive surface and a second reflective surface, and the fourth side P1S4 may form a third reflective surface.

The second reflective portion P2 may be generally formed of a polyhedron. For example, the second reflective portion P2 may be formed to have a pentahedral shape. However, the shape of the second reflective portion P2 is not limited to a pentahedron. A cross-sectional shape of the second reflective portion P2 parallel to the optical axis C may be substantially triangular.

The cross-section of the second reflective portion P2 may be configured in a triangular shape with three sides as illustrated in FIG. 1. For example, a cross-section of the second reflective portion P2 may include a first side P2S1, a second side P2S2, and a third side P2S3. However, the cross-section of the second reflective portion P2 is not necessarily triangular.

The second reflective portion P2 may be configured to image light exiting the first reflective portion P1 on the imaging plane IP. To this end, the second reflective portion P2 may include a plurality of reflective surfaces and a plurality of transmissive surfaces. In detail, the second reflective portion P2 may include three reflective surfaces and two transmissive surfaces.

The second reflective portion P2 may include a plurality of transmissive surfaces. For example, the first side P2S1 and the third side P2S3 of the second reflective portion P2 may form a first transmissive surface and a second transmissive surface, respectively. In detail, in the cross-sectional shape of the second reflective portion P2, the first side P2S1 closest to the first reflective portion P1 may form a first transmissive surface, and in the cross-sectional shape of the second reflective portion P2, the third side P2S3 closest to the imaging plane IP may form a second transmissive surface.

The second reflective portion P2 may include a plurality of reflective surfaces. For example, the first side P2S2, the second side P2S2, and the third side P2S3 of the second reflective portion P2 may form a first reflective surface, a second reflective surface, and a third reflective surface, respectively. In detail, the third side P2S3 may form a first reflective surface reflecting light incident through the first side P2S1 to the first side P2S1, the first side P2S1 may form a second reflective surface totally reflecting light reflected from the third side P2S3 to the second side P2S2, and the second side P2S2 may form a third reflective surface re-reflecting light totally reflected from the third side P2S3 toward the third side P2S3.

That is, in the second reflective portion P2, according to the present embodiment, the first side P2S1 may form a first transmissive surface and a second reflective surface, the second side P2S2 may form a third reflective surface, and the third side P2S3 may form a second transmissive surface and a first reflective surface.

The first reflective portion P1 and the second reflective portion P2 may be configured to establish a predetermined geometric relationship. For example, the third side P1S3 of the first reflective portion P1 may be configured to be parallel to the first side P2S1 of the second reflective portion P2. As another example, the fourth side P1S4 of the first reflective portion P1 may be configured to be parallel to the third side P2S3 of the second reflective portion P2. As another example, an angle θ1 between the third side P1S3 and the fourth side P1S4 of the first reflective portion P1 may be the same as an angle θ2 formed by the first side P2S1 and the third side P2S3 of the second reflective portion P2.

The first reflective portion P1 and the second reflective portion P2 may be disposed with a predetermined interval therebetween. For example, a distance d from the third side P1S3 of the first reflective portion P1 to the first side P2S1 of the second reflective portion P2 may be determined to be non-zero.

The imaging lens system 100 configured as described above may secure an optical path of a significant length (or distance) through the first reflective portion P1 and the second reflective portion P2, so that the imaging lens system 100 may be employed in implementing a high-performance telephoto camera module. In addition, in the imaging lens system 100, according to the present embodiment, since the first lens 110, the second lens 120, the third lens 130, the first reflective portion P1, and the second reflective portion P2 may be integrated into a limited space, the imaging lens system 100 may be mounted on a relatively small or ultra-thin terminal.

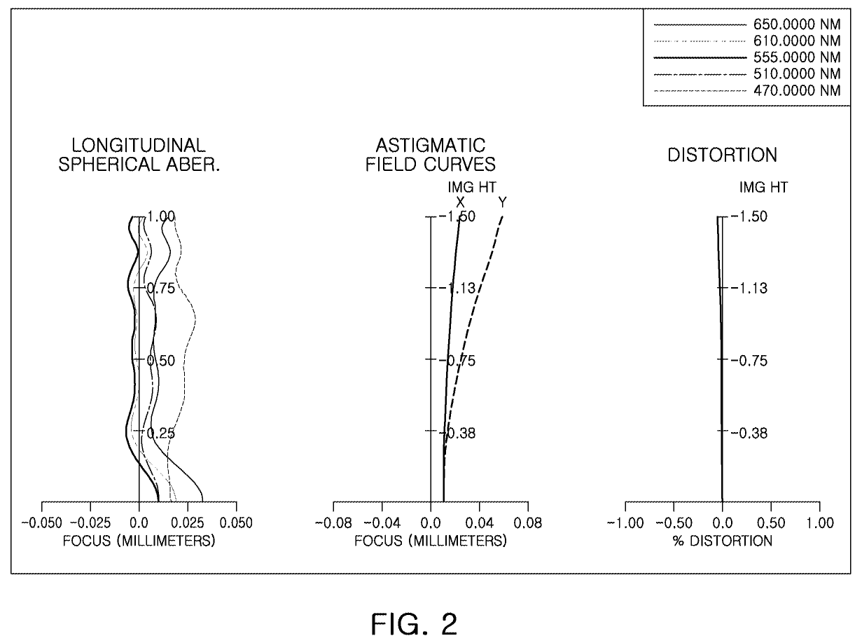

The optical imaging system 100 configured as described above may exhibit aberration characteristics of the form illustrated in FIG. 2. Tables 1 and 2 show lens characteristics and aspheric values of the imaging lens system according to the present embodiment.

Table 1

| Surface No. | Configuration | Radius of curvature | Thickness/di stance | Refractive index | Abbe’s No. | Focal length |
|---|---|---|---|---|---|---|
| S1 | First lens | 5.055 | 2.552 | 1.585 | 59.5 | 9.5296 |
| S2 | | 44.211 | 0.100 | | | |
| S3 | Second lens | 19.200 | 0.604 | 1.619 | 26.0 | -7.3745 |
| S4 | | 3.645 | 1.781 | | | |
| S5 | Third lens | 5.746 | 0.934 | 1.678 | 19.2 | 20.0009 |
| S6 | | 9.320 | 0.800 | | | |
| S7 | First reflective portion | Infinity | 1.800 | 1.519 | 64.2 | |
| S8 | | Infinity | 6.000 | 1.519 | 64.2 | |
| S9 | | Infinity | 2.000 | 1.519 | 64.2 | |
| S10 | | Infinity | 1.000 | 1.519 | 64.2 | |
| S11 | | Infinity | 2.000 | | | |
| S12 | Second reflective portion | Infinity | 1.000 | 1.519 | 64.2 | |
| S13 | | Infinity | 2.000 | 1.519 | 64.2 | |
| S14 | | Infinity | 5.000 | 1.519 | 64.2 | |
| S15 | | Infinity | 1.600 | 1.519 | 64.2 | |
| S16 | | Infinity | 1.124 | 1.519 | 64.2 | |
| S17 | Imaging plane | Infinity | -0.010 | | | |

Table 2

| Surface No. | S1 | S2 | S3 | S4 | S5 | S6 |
|---|---|---|---|---|---|---|
| K | 0 | 0 | 3.853E+01 | 2.185E-01 | -6.926E-01 | 8.950E+00 |
| A | 0 | 0 | 1.402E-02 | 1.702E-02 | 5.213E-03 | 2.804E-03 |
| B | 0 | 0 | 1.316E-03 | -1.545E-04 | -3.164E-04 | -4.304E-04 |
| C | 0 | 0 | -1.310E-05 | 1.933E-04 | 1.675E-05 | -1.909E-04 |
| D | 0 | 0 | 3.115E-04 | 1.730E-05 | -3.925E-07 | -1.245E-04 |
| E | 0 | 0 | 0 | 0 | 0 | 0 |
| F | 0 | 0 | 0 | 0 | 0 | 0 |
| G | 0 | 0 | 0 | 0 | 0 | 0 |
| H | 0 | 0 | 0 | 0 | 0 | 0 |
| J | 0 | 0 | 0 | 0 | 0 | 0 |

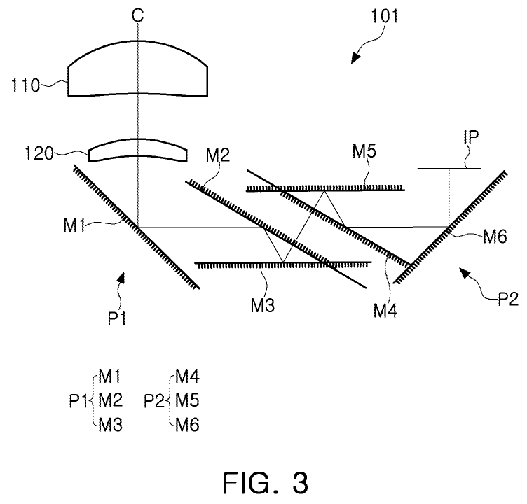

Next, an example embodiment of the imaging lens system 100 according to the first embodiment will be described with reference to FIGS. 3 to 7. For reference, in the following description, a detailed description of the same or similar configuration as that illustrated in FIG. 1 will be omitted. In addition, in the following description, some components may be given reference numerals different from those of the aforementioned embodiments.

The optical imaging system 100, according to the first embodiment, may be modified to the form illustrated in FIGS. 3 to 7.

First, an imaging lens system, according to a first example embodiment, will be described with reference to FIG. 3.

In an imaging lens system 101, according to the first example embodiment, the first reflective portion P1 and the second reflective portion P2 may include a plurality of reflective members. In detail, the first reflective portion P1 may include a first reflective member M1, a second reflective member M2, and a third reflective member M3, and the second reflective portion P2 may include a fourth reflective member M3, a fifth reflective member M5, and a sixth reflective member M6.

In the first reflective portion P1, the first reflective member M1 may reflect light incident from the second lens 120 to the second reflective member M2, the second reflective member M2 may totally reflect light reflected through the first reflective member M1 to the third reflective member M3, and the third reflective member M3 may reflect light reflected through the second reflective member M2 to the second reflective portion P2. For reference, in the first reflective portion P1, the second reflective member M2 may be configured to reflect light from the first reflective member M1 and transmit light from the third reflective member M3 simultaneously.

In the second reflective portion P2, the fourth reflective member M4 transmits light incident from the first reflective member P1 and totally reflects light reflected from the fifth reflective member M5 to the sixth reflective member M6, the fifth reflective member M5 reflects light incident from the first reflective portion P1 to the fourth reflective member M4, and the sixth reflective member M6 may reflect light reflected from the fourth reflective member M4 to the imaging plane IP.

The imaging lens system 101, according to the first example embodiment, may include two lenses. For example, the optical imaging system 101 may include a first lens 110 and a second lens 120 sequentially arranged from an object side. In the first example embodiment, the first lens 110 may have positive refractive power, and may have a convex object-side surface and a concave image-side surface. In the first example embodiment, the second lens 120 may have positive or negative refractive power, and may have a convex object-side surface and a concave image-side surface. However, the refractive power and shape of the first lens 110 and the second lens 120 are not limited to the aforementioned shapes.

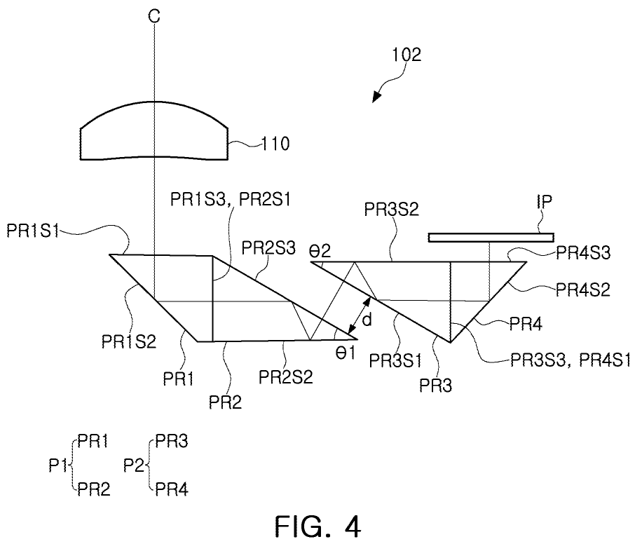

According to a second example embodiment, an imaging lens system will be described with reference to FIG. 4.

In an imaging lens system 102, according to the second example embodiment, each of the first reflective portion P1 and the second reflective portion P2 may include a plurality of prisms. In detail, the first reflective portion P1 may include a first prism PR1 and a second prism PR2, and the second reflective portion P2 may include a third prism P3 and a fourth prism P4.

The first reflective portion P1 may be configured in a form in which the first prism PR1 and the second prism PR2 are combined or joined. In detail, one surface of the first prism PR1 and one surface of the second prism PR2 may be configured to be parallel or may be in close contact with each other without an air gap.

In the first reflective portion P1, a first surface PR1S1 and a second surface PR1 S2 of the first prism PR1 may form a first transmissive surface and a first reflective surface, respectively, a second surface PR2S2 and a third surface PR2S3 of the second prism PR2 may form a third reflective surface and a second reflective surface, respectively, and the third surface PR2S3 of the second prism PR2 may form a second transmissive surface. In addition, the third surface PR1S3 of the first prism PR1 may be configured to be parallel to the first surface PR2S1 of the second prism PR2 or may join the first surface PR2S1 of the second prism PR2 without a gap.

The second reflective portion P2 may be configured in a form in which the third prism PR3 and the fourth prism PR4 are combined or joined. In detail, one surface of the third prism PR3 and one surface of the fourth prism PR4 may be configured to be parallel or may be in close contact with each other without an air gap.

In the second reflective portion P2, the first surface PR3S1 of the third prism PR3 may form a first transmissive surface and a second reflective surface, the second surface PR3S2 of the third prism PR3 may form a first reflective surface, a second surface PR4S2 of the fourth prism PR4 may form a third reflective surface, and a third surface PR4S3 of the fourth prism PR4 may form a second transmissive surface. In addition, the third surface PR3S3 of the third prism PR3 may be configured to be parallel to the first surface PR4S1 of the fourth prism PR4 or may join the first surface PR4S1 of the fourth prism PR4 without a gap.

The imaging lens system 102, according to the second example embodiment, may include a single lens. For example, the optical imaging system 102 may include the first lens 110. In the second example embodiment, the first lens 110 may have positive refractive power, and may have a convex object-side surface and a concave image-side surface. However, the refractive power and shape of the first lens 110 are not limited to the aforementioned shape.

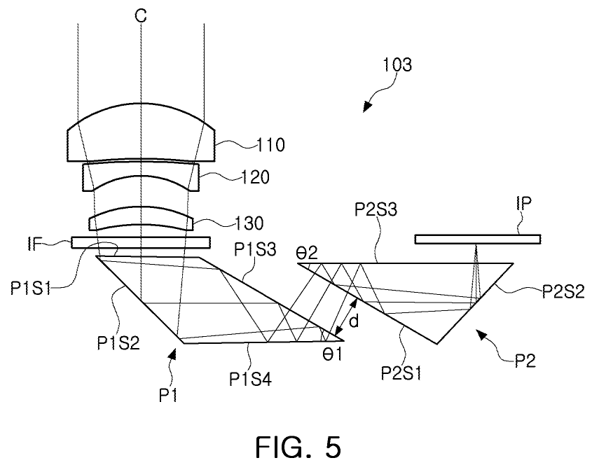

An imaging lens system according to a third example embodiment to a fifth example embodiment will be described with reference to FIGS. 5 to 7. For reference, in the following description, a detailed description of the same or similar configuration as that illustrated in FIG. 1 will be omitted.

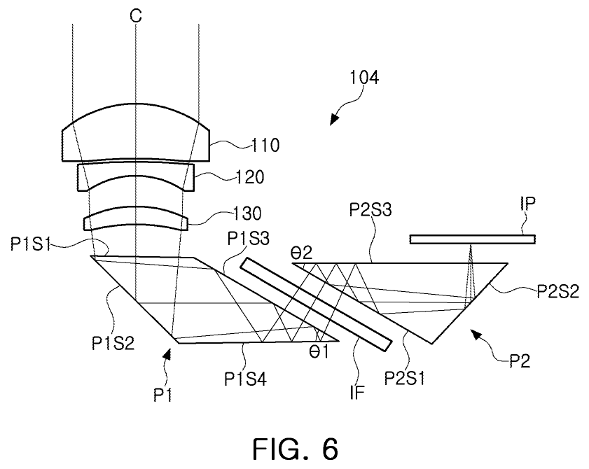

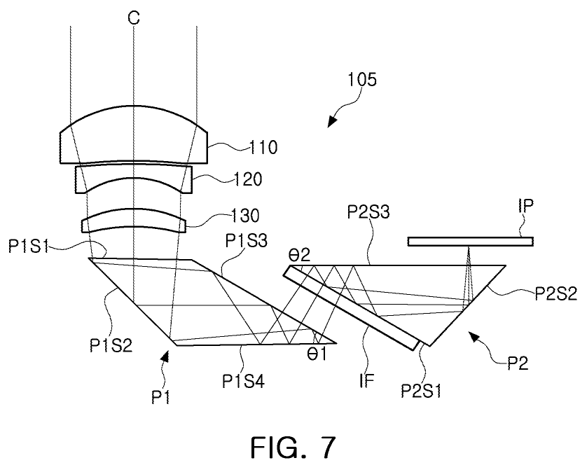

Optical imaging systems 103, 104, and 105, according to the third to fifth example embodiments, may further include a filter IF. As an example, the imaging lens system 103, according to the third example embodiment, may further include a filter IF disposed between the third lens 130 and the first reflective portion P1 as illustrated in FIG. 5, the imaging lens system 104, according to the fourth example embodiment may include a filter IF disposed between the first reflective portion P1 and the second reflective portion P2 as illustrated in FIG. 6, and the imaging lens system 105 according to the fifth example embodiment may include a filter IF attached to or integrally formed with one surface of the first reflective portion P1 or the second reflective portion P2 as illustrated in FIG. 7.

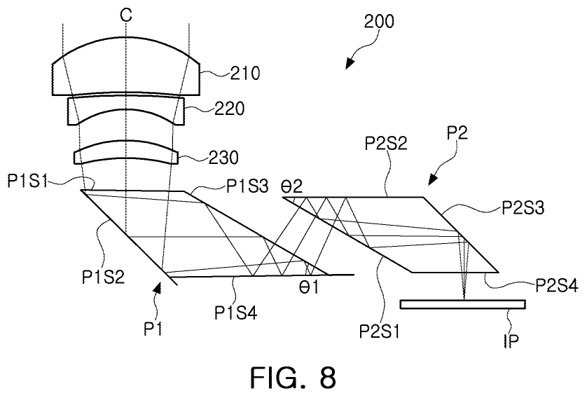

Next, an imaging lens system according to a second embodiment will be described with reference to FIG. 8.

The imaging lens system 200, according to the present embodiment, includes a lens group including a first lens 210, a second lens 220, a third lens 230, a first reflective portion P1, and a second reflective portion P2. However, the configuration of the imaging lens system 200 is not limited to the aforementioned members. For example, the optical imaging system 200 may further include one or more lenses.

The first lens 210 to the third lens 230 may be sequentially disposed from an object side. For example, the second lens 220 may be disposed on an image side of the first lens 210, and the third lens 230 may be disposed on an image side of the second lens 220. The first lens 210 to the third lens 230 may be disposed with a predetermined interval therebetween. For example, the image-side surface of the first lens 210 may not be in contact with an object-side surface of the second lens 220, and an image-side surface of the second lens 220 may be disposed not to contact the object-side surface of the third lens 230. However, the first lens 210 to the third lens 230 are not necessarily disposed in a non-contact state. For example, the image-side surface of the first lens 210 may contact the object-side surface of the second lens 220 or the image-side surface of the second lens 220 may contact the object-side surface of the third lens 230.

Next, the characteristics of the first lens 210 to the third lens 230 will be described.

The first lens 210 has refractive power. For example, the first lens 210 may have positive refractive power. One surface of the first lens 210 may have a convex shape. For example, the first lens 210 may have a convex object-side surface. The first lens 210 may have a concave image-side surface. However, the image-side surface of the first lens 210 is not limited to a concave shape. For example, if desired, the first lens 210 may have a convex image-side surface. The first lens 210 may include a spherical surface. For example, both the object-side surface and the image-side surface of the first lens 210 may be formed of a spherical surface.

The second lens 220 has refractive power. For example, the second lens 220 may have negative refractive power. One surface of the second lens 220 may have a convex shape. For example, the second lens 220 may have a convex object-side surface. However, the object-side surface of the second lens 220 is not limited to a convex shape. For example, if desired, the second lens 220 may have a concave object-side surface. One surface of the second lens 220 may have a concave shape. For example, the second lens 220 may have a concave object-side surface. The second lens 220 may include an aspherical surface. For example, at least one of the object-side surface and the image-side surface of the second lens 220 may be formed as an aspherical surface.

The third lens 230 has refractive power. For example, the third lens 230 may have positive or negative refractive power. The third lens 230 may have a convex shape. For example, the third lens 230 may have a convex object-side surface. One surface of the third lens 230 may have a concave shape. For example, the third lens 230 may have a concave image-side surface. However, the image-side surface of the third lens 230 is not limited to a concave shape. For example, if desired, the third lens 230 may have a convex image-side surface. The third lens 230 may include an aspherical surface. For example, at least one of the object-side surface and the image-side surface of the third lens 230 may be formed as an aspherical surface.

The first reflective portion P1 and the second reflective portion P2 may be disposed between the third lens 230 and the imaging plane IP. The first reflective portion P1 and the second reflective portion P2 may be configured to reduce an external distance from the image-side surface of the third lens 230 to the imaging plane IP. In detail, the first reflective portion P1 and the second reflective portion P2 may reduce an external distance or size from the image-side surface of the third lens 230 to the imaging plane, without substantially changing an optical path length (or BFL) from the image-side surface of the third lens 230 to the imaging plane. Therefore, the optical imaging system 200, according to the present embodiment, may be mounted on a relatively small or thin terminal as it is optically designed. The first reflective portion P1 and the second reflective portion P2 may be configured in a prism shape. However, the shapes of the first reflective portion P1 and the second reflective portion P2 are not limited to the prism.

Next, the shapes of the first reflective portion P1 and the second reflective portion P2 will be described.

The first reflective portion P1 may be generally formed of a polyhedron. For example, the first reflective portion P1 may be formed to have a hexahedral shape. However, the shape of the first reflective portion P1 is not limited to a hexahedron. The cross-sectional shape of the first reflective portion P1 parallel to the optical axis C (or a cross-sectional shape of the first reflective portion P1 in which the optical path is formed) may be substantially quadrangular. For example, the cross-section of the first reflective portion P1 may have a trapezoidal shape in which a pair of opposite sides are parallel.

The cross-section of the first reflective portion P1 may be configured in a quadrangular shape with four sides, as illustrated in FIG. 8. For example, the cross-section of the first reflective portion P1 may include a first side P1S1, a second side P1S2, a third side P1S3, and a fourth side P1S4. However, the cross-section of the first reflective portion P1 is not necessarily quadrangular.

The first reflective portion P1 is configured to refract light incident from the third lens 230 to the second reflective portion P2. To this end, the first reflective portion P1 may include a plurality of reflective surfaces and a plurality of transmissive surfaces. In detail, the first reflective portion P1 may include three reflective surfaces and two transmissive surfaces.

The first reflective portion P1 may include a plurality of transmissive surfaces. For example, the first side P1S1 and the third side P1S3 of the first reflective portion P1 may form a first transmissive surface and a second transmissive surface, respectively. In detail, in the cross-sectional shape of the first reflective portion P1, the first side P1S1 closest to the third lens 230 forms a first transmissive surface, and in the cross-sectional shape of the first reflective portion P1, the third side P1S3 closest to the second reflective portion P2 may form a second transmissive surface.

The first reflective portion P1 may include a plurality of reflective surfaces. For example, the second side P1S2, the third side P1S3, and the fourth side P1S4 of the first reflective portion P1 may form a first reflective surface, a second reflective surface, and a third reflective surface, respectively. In detail, the second side P1S2 may form a first reflective surface reflecting light incident through the first side P1S1, the third side P1S3 facing the second side P1S2 forms a second reflective surface reflecting light reflected from the second side P1S2 to the fourth side P1S4, and the fourth side P1S4 formed parallel to the first side P1S1 may form a third reflective surface re-reflecting light totally reflected from the third side P1S3 toward the third side P1S3.

That is, in the first reflective portion P1, according to the present embodiment, the first side P1S1 may form a first transmissive surface, the second side P1S2 may form a first reflective surface, the third side P1S3 may form a second transmissive surface and a second reflective surface, and the fourth side P1S4 may form a third reflective surface.

The second reflective portion P2 may be generally formed of a polyhedron. For example, the second reflective portion P2 may be formed to have a hexahedral shape. However, the shape of the second reflective portion P2 is not limited to a hexahedron. For example, a cross-sectional shape of the second reflective portion P2 parallel to the optical axis C may be substantially quadrangular.

The cross-section of the second reflective portion P2 may be configured in a triangular shape with four sides, as illustrated in FIG. 8. For example, a cross-section of the second reflective portion P2 may include a first side P2S1, a second side P2S2, a third side P2S3, and a fourth side P2S4. However, the cross-section of the second reflective portion P2 is not necessarily quadrangular.

The second reflective portion P2 may be configured to image light exiting the first reflective portion P1 on the imaging plane IP or reflect the light. To this end, the second reflective portion P2 may include a plurality of reflective surfaces and a plurality of transmissive surfaces. In detail, the second reflective portion P2 may include three reflective surfaces and two transmissive surfaces.

The second reflective portion P2 may include a plurality of transmissive surfaces. For example, the first side P2S1 and the fourth side P2S4 of the second reflective portion P2 may form a first transmissive surface and a second transmissive surface, respectively. In detail, in the cross-sectional shape of the second reflective portion P2, the first side P2S1 closest to the first reflective portion P1 may form a first transmissive surface, and in the cross-sectional shape of the second reflective portion P2, the fourth side P2S4 closest to the imaging plane IP may form a second transmissive surface.

The second reflective portion P2 may include a plurality of reflective surfaces. For example, the first side P2S2, the second side P2S2, and the third side P2S3 of the second reflective portion P2 may form a first reflective surface, a second reflective surface, and a third reflective surface, respectively. In detail, the second side P2S2 may form a first reflective surface reflecting light incident through the first side P2S1 to the first side P2S1, the first side P2S1 may form a second reflective surface totally reflecting light reflected from the second side P2S2 to the third side P2S3, and the third side P2S3 may form a third reflective surface re-reflecting light totally reflected from the first side P2S1 to the fourth side P2S4 or the imaging plane IP.

That is, in the second reflective portion P2, according to the present embodiment, the first side P2S1 may form a first transmissive surface and a second reflective surface, the second side P2S2 may form a first reflective surface, the third side P2S3 may form a third reflective surface, and the fourth side P2S4 may form a second transmissive surface.

The first reflective portion P1 and the second reflective portion P2 may be configured to establish a predetermined geometric relationship. For example, the third side P1S3 of the first reflective portion P1 may be configured to be parallel to the first side P2S1 of the second reflective portion P2. As another example, the fourth side P1S4 of the first reflective portion P1 may be configured to be parallel to the second side P2S2 of the second reflective portion P2. As another example, an angle θ1 between the third side P1S3 and the fourth side P1S4 of the first reflective portion P1 may be the same as an angle θ2 formed by the first side P2S1 and the second side P2S2 of the second reflective portion P2.

The first reflective portion P1 and the second reflective portion P2 may be disposed with a predetermined interval therebetween. However, the first reflective portion P1 and the second reflective portion P2 are not necessarily spaced apart from each other. For example, one surface of the first reflective portion P1 and one surface of the second reflective portion P2 may be disposed to be in contact with each other.

The imaging lens system 200 configured as described above may secure an optical path of a significant length (or distance) through the first reflective portion P1 and the second reflective portion P2, so that the imaging lens system 200 may be employed in implementing a high-performance telephoto camera module. In addition, in the imaging lens system 200, according to the present embodiment, since the first lens 210, the second lens 220, the third lens 230, the first reflective portion P1, and the second reflective portion P2 may be integrated into a limited space, the imaging lens system 200 may be mounted on a relatively small or ultra-thin terminal.

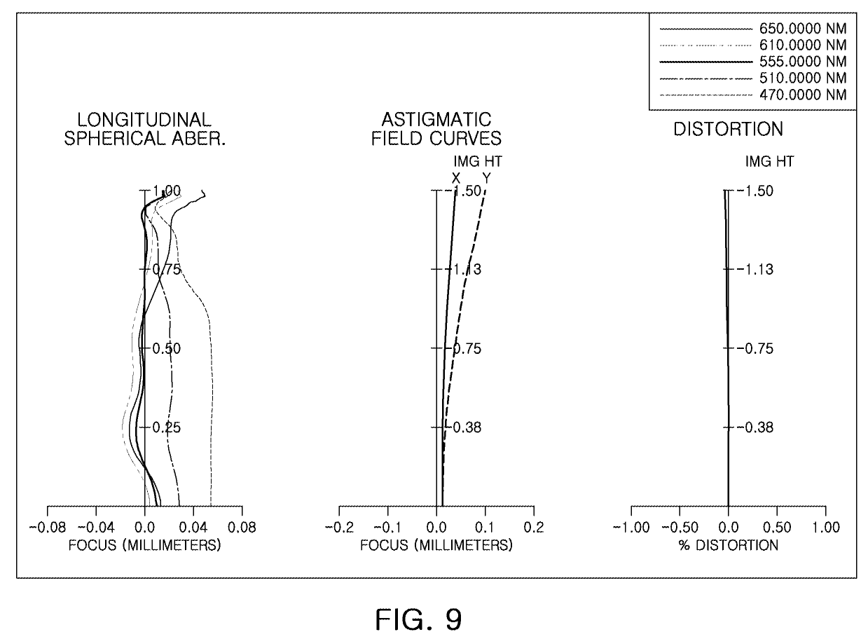

The optical imaging system 200 configured as described above may exhibit aberration characteristics of the form illustrated in FIG. 9. Tables 3 and 4 show lens characteristics and aspheric values of the imaging lens system according to the present embodiment.

Table 3

| Surface No. | Configuration | Radius of curvature | Thickness/di stance | Refractive index | Abbe’s No. | Focal length |
|---|---|---|---|---|---|---|
| S1 | First lens | 5.056 | 2.550 | 1.585 | 59.5 | 9.6058 |
| S2 | | 41.104 | 0.096 | | | |
| S3 | Second lens | 18.236 | 0.620 | 1.619 | 26.0 | -7.0948 |
| S4 | | 3.494 | 1.408 | | | |
| S5 | Third lens | 5.666 | 0.799 | 1.667 | 20.3 | 18.6031 |
| S6 | | 9.842 | 2.000 | | | |
| S7 | First reflective portion | Infinity | 2.000 | 1.518 | 64.2 | |
| S8 | | Infinity | 6.000 | 1.518 | 64.2 | |
| S9 | | Infinity | 2.000 | 1.518 | 64.2 | |
| S10 | | Infinity | 1.000 | 1.518 | 64.2 | |
| S11 | | Infinity | 2.000 | | | |
| S12 | Second reflective portion | Infinity | 1.000 | 1.518 | 64.2 | |
| S13 | | Infinity | 2.000 | 1.518 | 64.2 | |
| S14 | | Infinity | 5.000 | 1.518 | 64.2 | |
| S15 | | Infinity | 1.500 | 1.518 | 64.2 | |
| S16 | | Infinity | 0.500 | | | |
| S17 | | Infinity | 0.210 | 1.518 | 64.2 | |
| S18 | | Infinity | 0.448 | | | |
| S19 | Imaging plane | Infinity | -0.010 | | | |

Table 4

| Surface No. | S1 | S2 | S3 | S4 | S5 | S6 |
|---|---|---|---|---|---|---|
| K | 0 | 0 | 3.899E+01 | 2.304E-01 | -5.662E-01 | 9.108E+00 |
| A | 0 | 0 | 1.325E-02 | 1.731 E-02 | 5.315E-03 | 2.446E-03 |
| B | 0 | 0 | 1.404E-03 | -4.154E-04 | -3.214E-04 | -3.917E-04 |
| C | 0 | 0 | 1.519E-04 | 3.083E-04 | 1.504E-05 | -1.280E-04 |
| D | 0 | 0 | 4.678E-04 | 6.369E-05 | -5.662E-09 | -1.154E-04 |
| E | 0 | 0 | 0 | 0 | 0 | 0 |
| F | 0 | 0 | 0 | 0 | 0 | 0 |
| G | 0 | 0 | 0 | 0 | 0 | 0 |
| H | 0 | 0 | 0 | 0 | 0 | 0 |
| J | 0 | 0 | 0 | 0 | 0 | 0 |

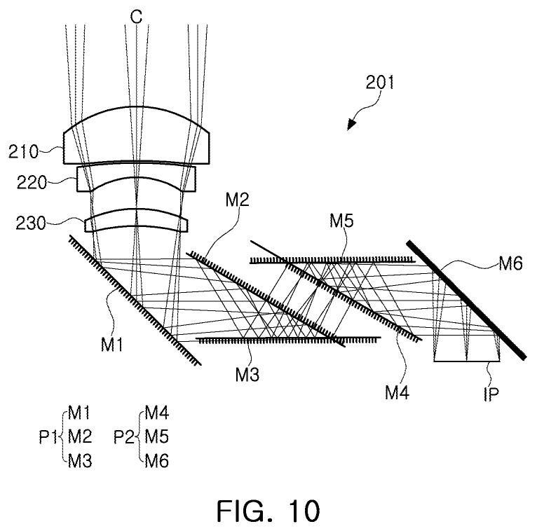

The optical imaging system 200, according to the second embodiment, may be modified to the form illustrated in FIG. 10. An example embodiment of the imaging lens system will be described with reference to FIG. 10.

In an imaging lens system 201, according to an example embodiment, the first reflective portion P1 and the second reflective portion P2 may include a plurality of reflective members. In detail, the first reflective portion P1 may include a first reflective member M1, a second reflective member M2, and a third reflective member M3, and the second reflective portion P2 may include a fourth reflective member M3, a fifth reflective member M5, and a sixth reflective member M6.

In the first reflective portion P1, the first reflective member M1 may reflect light incident from the second lens 120 to the second reflective member M2, the second reflective member M2 may totally reflect light reflected through the first reflective member M1 to the third reflective member M3, and the third reflective member M3 may reflect light reflected through the second reflective member M2 to the second reflective portion P2. For reference, in the first reflective portion P1, the second reflective member M2 may be configured to reflect light from the first reflective member M1 and transmit light from the third reflective member M3 simultaneously.

In the second reflective portion P2, the fourth reflective member M4 transmits light incident from the first reflective member P1 and totally reflects light reflected from the fifth reflective member M5 to the sixth reflective member M6, the fifth reflective member M5 reflects light incident from the first reflective portion P1 to the fourth reflective member M4, and the sixth reflective member M6 may reflect light reflected from the fourth reflective member M4 to the imaging plane IP.

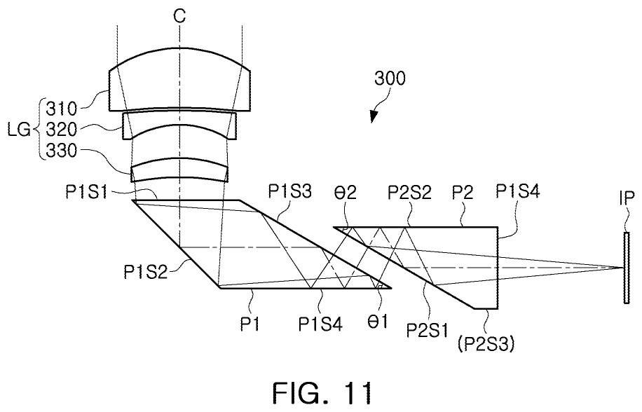

Next, an imaging lens system according to a third embodiment will be described with reference to FIG. 11.

An imaging lens system 300, according to the present embodiment, includes a lens group LG, a first reflective portion P1, and a second reflective portion P2. However, a configuration of the imaging lens system 300 is not limited to the aforementioned members.

The lens group LG may include a plurality of lenses. For example, the lens group LG may include a first lens 310, a second lens 320, and a third lens 330. However, the lens group LG configuration is not limited to the first lens 310 to the third lens 330. The first lens 310 to the third lens 330 may be sequentially disposed from the object side. For example, the second lens 320 may be disposed on the image side of the first lens 310, and the third lens 330 may be disposed on the image side of the second lens 320. The first lens 310 to the third lens 330 may be disposed at a predetermined interval. For example, the image-side surface of the first lens 310 may not in contact with an object-side surface of the second lens 320, and the image-side surface of the second lens 320 may not be in contact with an object-side surface of the third lens 330. However, the first lens 310 to the third lens 330 are not necessarily disposed in a non-contact state. For example, the image-side surface of the first lens 310 may be disposed to be in contact with the object-side surface of the second lens 320, or the image-side surface of the second lens 320 may be disposed to be in contact with the object-side surface of the third lens 330.

Next, the characteristics of the first lens 310 to the third lens 330 will be described.

The first lens 310 has refractive power. For example, the first lens 310 may have positive refractive power. One surface of the first lens 310 may have a convex shape. For example, the first lens 310 may have a convex object-side surface. The first lens 310 may have a concave image-side surface. However, the image-side surface of the first lens 310 is not limited to a concave shape. For example, if desired, the first lens 310 may have a convex image-side surface. The first lens 310 may include a spherical surface. For example, both the object-side surface and the image-side surface of the first lens 310 may be formed of a spherical surface.

The second lens 320 has refractive power. For example, the second lens 320 may have negative refractive power. One surface of the second lens 320 may have a convex shape. For example, the second lens 320 may have a convex object-side surface. However, the object-side surface of the second lens 320 is not limited to a convex shape. For example, if desired, the second lens 320 may have a concave object-side surface. One surface of the second lens 320 may have a concave shape. For example, the second lens 320 may have a concave object-side surface. The second lens 320 may include an aspherical surface. For example, at least one of the object-side surface and the image-side surface of the second lens 320 may be formed as an aspherical surface.

The third lens 330 has refractive power. For example, the third lens 330 may have positive or negative refractive power. The third lens 330 may have a convex shape. For example, the third lens 330 may have a convex shape on the object-side surface. One surface of the third lens 330 may have a concave shape. For example, an image-side surface of the third lens 330 may have a concave shape. However, the image-side surface of the third lens 330 is not limited to a concave shape. For example, the image-side surface of the third lens 330 may have a convex shape if desired. The third lens 330 may include an aspherical surface. For example, at least one of the object-side surface and the image-side surface of the third lens 330 may be formed as an aspherical surface.

The first reflective portion P1 and the second reflective portion P2 may be disposed between the third lens 330 and the imaging plane IP. The first reflective portion P1 and the second reflective portion P2 may be configured to reduce an external distance from the image-side surface of the third lens 330 to the imaging plane IP. In detail, the first reflective portion P1 and the second reflective portion P2 may reduce an external distance or size from the image-side surface of the third lens 330 to the imaging plane, without substantially changing an optical path length (or BFL) from the image-side surface of the third lens 330 to the imaging plane. Therefore, the optical imaging system 200, according to the present embodiment, may be mounted on a relatively small or thin terminal as it is optically designed. The first reflective portion P1 and the second reflective portion P2 may be configured in a prism shape. However, the shapes of the first reflective portion P1 and the second reflective portion P2 are not limited to the prism.

Next, the shapes of the first reflective portion P1 and the second reflective portion P2 will be described.

The first reflective portion P1 may be generally formed of a polyhedron. For example, the first reflective portion P1 may be formed to have a hexahedral shape. However, the shape of the first reflective portion P1 is not limited to a hexahedron. The cross-sectional shape of the first reflective portion P1 parallel to the optical axis C (or a cross-sectional shape of the first reflective portion P1 in which the optical path is formed) may be substantially quadrangular. For example, the cross-section of the first reflective portion P1 may have a trapezoidal shape in which a pair of opposite sides are parallel.

The cross-section of the first reflective portion P1 may be configured in a quadrangular shape with four sides as illustrated in FIG. 11. For example, the cross-section of the first reflective portion P1 may include a first side P1S1, a second side P1S2, a third side P1S3, and a fourth side P1S4. However, the cross-section of the first reflective portion P1 is not necessarily quadrangular.

The first reflective portion P1 is configured to refract light incident from the third lens 330 to the second reflective portion P2. To this end, the first reflective portion P1 may include a plurality of reflective surfaces and a plurality of transmissive surfaces. In detail, the first reflective portion P1 may include three reflective surfaces and two transmissive surfaces.

The first reflective portion P1 may include a plurality of transmissive surfaces. For example, the first side P1S1 and the third side P1S3 of the first reflective portion P1 may form a first transmissive surface and a second transmissive surface, respectively. In detail, in the cross-sectional shape of the first reflective portion P1, the first side P1S1 closest to the third lens 330 forms a first transmissive surface, and in the cross-sectional shape of the first reflective portion P1, the third side P1S3 closest to the second reflective portion P2 may form a second transmissive surface.

The first reflective portion P1 may include a plurality of reflective surfaces. For example, the second side P1S2, the third side P1S3, and the fourth side P1S4 of the first reflective portion P1 may form a first reflective surface, a second reflective surface, and a third reflective surface, respectively. In detail, the second side P1S2 may form a first reflective surface reflecting light incident through the first side P1S1, the third side P1S3 facing the second side P1S2 forms a second reflective surface reflecting light reflected from the second side P1S2 to the fourth side P1S4, and the fourth side P1S4 formed parallel to the first side P1S1 may form a third reflective surface re-reflecting light totally reflected from the third side P1S3 toward the third side P1S3.

That is, in the first reflective portion P1, according to the present embodiment, the first side P1S1 may form a first transmissive surface, the second side P1S2 may form a first reflective surface, the third side P1S3 may form a second transmissive surface and a second reflective surface, and the fourth side P1S4 may form a third reflective surface.

The second reflective portion P2 may be generally formed of a polyhedron. For example, the second reflective portion P2 may be formed to have a hexahedral shape. However, the shape of the second reflective portion P2 is not limited to a hexahedron. A cross-sectional shape of the second reflective portion P2 parallel to the optical axis C may be substantially quadrangular.

The cross-section of the second reflective portion P2 may be configured in a triangular shape with four sides as illustrated in FIG. 11. For example, a cross-section of the second reflective portion P2 may include a first side P2S1, a second side P2S2, a third side P2S3, and a fourth side P2S4. Here, the third side P2S3 may be omitted if desired (in this case, the cross-section of the second reflection unit P2 may be formed of a triangle).

The second reflective portion P2 may be configured to image light exiting the first reflective portion P1 on the imaging plane IP or reflect the light. To this end, the second reflective portion P2 may include a plurality of reflective surfaces and a plurality of transmissive surfaces. In detail, the second reflective portion P2 may include two reflective surfaces and two transmissive surfaces.

The second reflective portion P2 may include a plurality of transmissive surfaces. For example, the first side P2S1 and the fourth side P2S4 of the second reflective portion P2 may form a first transmissive surface and a second transmissive surface, respectively. In detail, in the cross-sectional shape of the second reflective portion P2, the first side P2S1 closest to the first reflective portion P1 may form a first transmissive surface, and in the cross-sectional shape of the second reflective portion P2, the fourth side P2S4 closest to the imaging plane IP may form a second transmissive surface.

The second reflective portion P2 may include a plurality of reflective surfaces. For example, the first side P2S2 and the second side P2S2, of the second reflective portion P2 may form a first reflective surface and a second reflective surface, respectively. In detail, the second side P2S2 may form a first reflective surface reflecting light incident through the first side P2S1 to the first side P2S1, and the first side P2S1 may form a second reflective surface totally reflecting light reflected from the second side P2S2 to the fourth side P2S4 or the imaging plane IP.

That is, in the second reflective portion P2, according to the present embodiment, the first side P2S1 may form a first transmissive surface and a second reflective surface, the second side P2S2 may form a first reflective surface, and the fourth side P2S4 may form a second transmissive surface.

The first reflective portion P1 and the second reflective portion P2 may be configured to establish a predetermined geometric relationship. For example, the third side P1S3 of the first reflective portion P1 may be configured to be parallel to the first side P2S1 of the second reflective portion P2. As another example, the fourth side P1S4 of the first reflective portion P1 may be configured to be parallel to the second side P2S2 of the second reflective portion P2. As another example, an included angle θ1 between the third side P1S3 and the fourth side P1S4 of the first reflective portion P1 may be substantially the same as an included angle θ2 between the first side P2S1 and the second side P2S2 of the second reflective portion P2.

The first reflective portion P1 and the second reflective portion P2 may be disposed with a predetermined interval therebetween. However, the first reflective portion P1 and the second reflective portion P2 are not necessarily spaced apart from each other. For example, one surface of the first reflective portion P1 and one surface of the second reflective portion P2 may be disposed to be in contact with each other.

The imaging lens system 300 configured as described above may secure an optical path of a significant length (or distance) through the first reflective portion P1 and the second reflective portion P2, so that the imaging lens system 200 may be employed in implementing a high-performance telephoto camera module. In addition, in the imaging lens system 300, according to the present embodiment, since the first lens 310, the second lens 320, the third lens 330, the first reflective portion P1, and the second reflective portion P2 may be integrated into a limited space, the imaging lens system 200 may be mounted on a relatively small or ultra-thin terminal.

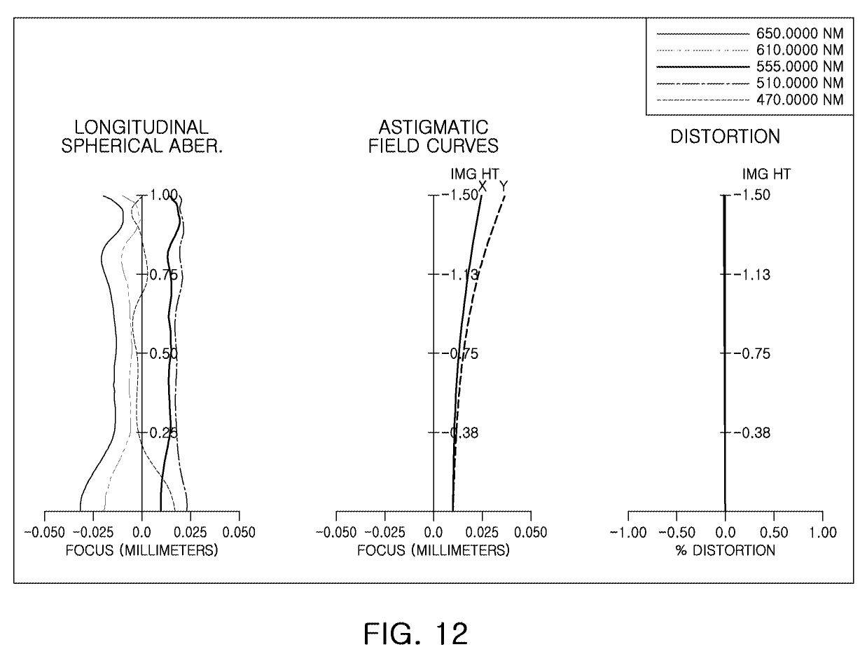

The optical imaging system 300 configured as described above may exhibit aberration characteristics of the form illustrated in FIG. 12. Tables 5 and 6 show lens characteristics and aspheric values of the imaging lens system according to the present embodiment.

Table 5

| Surface No. | Configuration | Radius of curvature | Thickness/di stance | Refractive index | Abbe’s No. | Focal length |
|---|---|---|---|---|---|---|
| S1 | First lens | 5.027 | 2.550 | 1.546 | 56.1 | 10.2279 |
| S2 | | 41.350 | 0.096 | | | |
| S3 | Second lens | 18.336 | 0.620 | 1.640 | 24.0 | -7.0808 |
| S4 | | 3.584 | 1.408 | | | |
| S5 | Third lens | 5.510 | 0.799 | 1.678 | 19.2 | 15.9217 |
| S6 | | 10.604 | 1.000 | | | |
| S7 | First reflective portion | Infinity | 2.000 | 1.518 | 64.2 | |
| S8 | | Infinity | 6.000 | 1.518 | 64.2 | |
| S9 | | Infinity | 2.000 | 1.518 | 64.2 | |
| S10 | | Infinity | 1.000 | 1.518 | 64.2 | |
| S11 | | Infinity | 1.000 | | | |
| S12 | Second reflective portion | Infinity | 1.000 | 1.518 | 64.2 | |
| S13 | | Infinity | 2.000 | 1.518 | 64.2 | |
| S14 | | Infinity | 4.000 | 1.518 | 64.2 | |
| S15 | | Infinity | 0.000 | 1.518 | 64.2 | |
| S16 | | Infinity | 0.000 | | | |
| S17 | | Infinity | 0.000 | | | |
| S18 | | Infinity | 5.383 | | | |
| S19 | Imaging plane | Infinity | 0.000 | | | |

Table 6

| Surface No. | S1 | S2 | S3 | S4 | S5 | S6 |
|---|---|---|---|---|---|---|
| K | 0 | 0 | 3.802E+01 | 2.334E-01 | -7.633E-01 | 9.249E+00 |
| A | 0 | 0 | 1.295E-02 | 1.658E-02 | 4.784E-03 | 8.126E-04 |
| B | 0 | 0 | 1.454E-03 | 2.157E-04 | -2.739E-04 | -4.059E-04 |
| C | 0 | 0 | -2.283E-05 | 1.486E-04 | 5.443E-06 | 3.395E-05 |
| D | 0 | 0 | 2.983E-04 | -3.554E-06 | 1.006E-05 | -4.334E-05 |
| E | 0 | 0 | 0 | 0 | 0 | 0 |
| F | 0 | 0 | 0 | 0 | 0 | 0 |
| G | 0 | 0 | 0 | 0 | 0 | 0 |
| H | 0 | 0 | 0 | 0 | 0 | 0 |
| J | 0 | 0 | 0 | 0 | 0 | 0 |

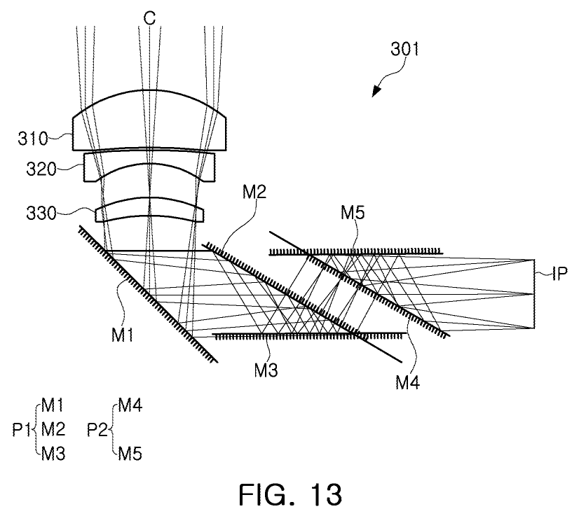

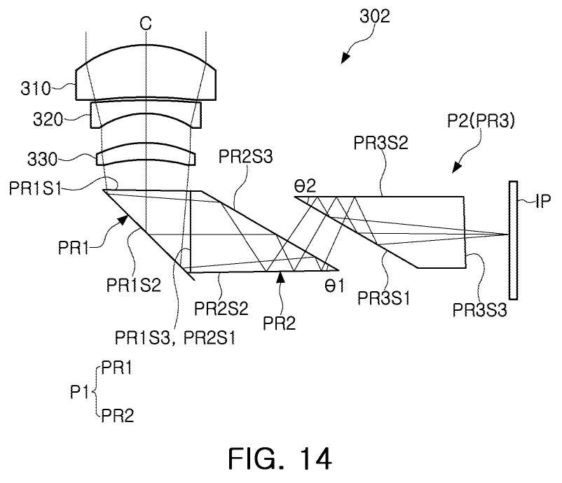

The optical imaging system 300, according to the third embodiment, may be modified to the form illustrated in FIGS. 13 and 14.

First, a first example embodiment of the imaging lens system will be described with reference to FIG. 13.

In an imaging lens system 301, according to the first example embodiment, the first reflective portion P1 and the second reflective portion P2 may include a plurality of reflective members. In detail, the first reflective portion P1 may include a first reflective member M1, a second reflective member M2, and a third reflective member M3, and the second reflective portion P2 may include a fourth reflective member M3, and a fifth reflective member M5.

In the first reflective portion P1, the first reflective member M1 reflects the light incident from the second lens 120 to the second reflective member M2, and the second reflective member M2 is the first reflective member. The light reflected through (M1) is totally reflected by the third reflective member M3, and the third reflective member M3 reflects the light reflected through the second reflective member M2 to the second reflective portion P2. For reference, the second reflective member M2 in the first reflective portion P1 may be configured to reflect the light of the first reflective member M1 and transmit the light from the third reflective member M3 simultaneously.

In the second reflective portion P2, the fourth reflective member M4 transmits light incident from the first reflective portion P1 and totally reflects light reflected from the fifth reflective member M5 to the imaging plane IP, and the fifth reflective member M5 may be configured to reflect light incident from the first reflective portion P1 to the fourth reflective member M4.

According to a second example embodiment, an imaging lens system will be described with reference to FIG. 14.

In an imaging lens system 302, according to the second example embodiment, the first reflective portion P1 may include a plurality of prisms. In detail, the first reflective portion P1 may include a first prism PR1 and a second prism PR2, and the second reflective portion P2 may include a third prism P3.

The first reflective portion P1 may be configured in a form in which the first prism PR1 and the second prism PR2 are combined or joined. In detail, one surface of the first prism PR1 and one surface of the second prism PR2 may be configured to be parallel or may be in close contact with each other without an air gap.

In the first reflective portion P1, a first surface PR1S1 and a second surface PR1S2 of the first prism PR1 may form a first transmissive surface and a first reflective surface, respectively, a second surface PR2S2 and a third surface PR2S3 of the second prism PR2 may form a third reflective surface and a second reflective surface, respectively, and the third surface PR2S3 of the second prism PR2 may form a second transmissive surface. In addition, the third surface PR1S3 of the first prism PR1 may be configured to be parallel to the first surface PR2S1 of the second prism PR2 or may join the first surface PR2S1 of the second prism PR2 without a gap.

The second reflective portion P2 may include one third prism PR3. In the second reflective portion P2, the first surface PR3S1 of the third prism PR3 may form a first transmissive surface and a second reflective surface, the second surface PR3S2 may form a first reflective surface, and the third surface PR3S3 may form a second transmissive surface.

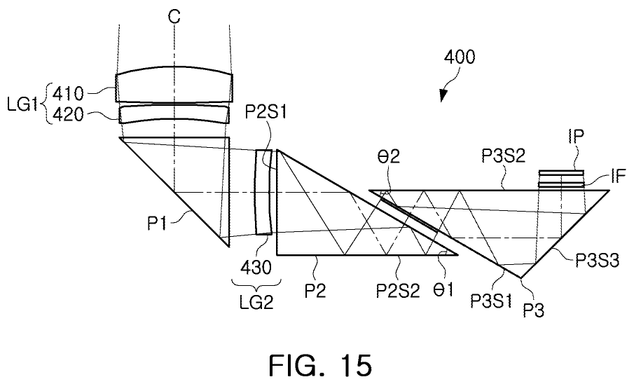

Next, an imaging lens system according to a fourth embodiment will be described with reference to FIG. 15.

An imaging lens system 400, according to the present embodiment, includes a first lens group LG1, a first reflective portion P1, a second lens group LG2, a second reflective portion P2, and a third reflective portion P3 sequentially arranged from an object side. However, the configuration of the imaging lens system 400 is not limited to the aforementioned members.

The first lens group LG1 may include a plurality of lenses. For example, the first lens group LG1 may include a first lens 410 and a second lens 420. However, the configuration of the first lens group LG1 is not limited to the first lens 410 and the second lens 420. The first lens 410 and the second lens 420 may be sequentially disposed from the object side. The first lens 410 and the second lens 420 may be disposed with a predetermined interval therebetween. For example, an image-side surface of the first lens 410 may be disposed not to contact with the object-side surface of the second lens 420.

Next, the characteristics of the first lens 410 and the second lens 420 will be described.

The first lens 410 has refractive power. For example, the first lens 410 may have positive refractive power. The first lens 410 has a convex object-side surface and a convex image-side surface. The first lens 410 may include a spherical surface. For example, both the object-side surface and the image-side surface of the first lens 410 may be formed of a spherical surface.

The second lens 420 has refractive power. For example, the second lens 420 may have negative refractive power. The second lens 420 has a convex object-side surface and a concave image-side surface. The second lens 420 may include an aspherical surface. For example, both the object-side surface and the image-side surface of the second lens 420 may be formed of an aspherical surface.

The first reflective portion P1 may be configured to totally reflect light incident through the first lens group LG1 to the second lens group LG2. For example, the first reflective portion P1 may be configured to reflect light incident through the first lens group LG1 in a substantially 90 degree direction.

The second lens group LG2 may include one or more lenses. For example, the second lens group LG2 may include a third lens 430. The third lens 430 has refractive power. For example, the third lens 430 may have negative refractive power. The third lens 430 has a convex object-side surface and a concave image-side surface. The third lens 430 may include an aspherical surface. For example, the image-side surface of the third lens 430 may be formed as an aspherical surface.

The second reflective portion P2 and the third reflective portion P3 may be disposed between the third lens 430 and the imaging plane IP. The second reflective portion P2 and the third reflective portion P3 may be configured to reduce an external distance from the image-side surface of the third lens 430 to the imaging plane IP. In detail, the second reflective portion P2 and the third reflective portion P3 may reduce an external distance or size from the image-side surface of the third lens 430 to the imaging plane, without substantially changing an optical path length (or BFL) from the image-side surface of the third lens 430 to the imaging plane. Therefore, the optical imaging system 400, according to the present embodiment, may be mounted on a relatively small or thin terminal as it is optically designed. The second reflective portion P2 and the third reflective portion P3 may be configured in a prism shape. However, the shapes of the second reflective portion P2 and the third reflective portion P3 are not limited to the prism.

Next, the shapes of the second reflective portion P2 and the third reflective portion P3 will be described.

A cross-section of the second reflective portion P2 may be configured as a triangle having three sides. For example, the cross-sectional shape of the second reflective portion P2 may be a triangle, including a first side P2S1, a second side P2S2, and a third side P2S3.

The second reflective portion P2 is configured to refract light incident from the third lens 430 to the third reflective portion P3. To this end, the second reflective portion P2 may include a plurality of reflective surfaces and a plurality of transmissive surfaces. In detail, the second reflective portion P2 may include two reflective surfaces and two transmissive surfaces.

The second reflective portion P2 may include a plurality of transmissive surfaces. For example, the first side P2S1 and the third side P2S3 of the second reflective portion P2 may form a first transmissive surface and a second transmissive surface, respectively. In detail, in the cross-sectional shape of the second reflective portion P2, the first side P2S1 closest to the third lens 430 may form a first transmissive surface, and in the cross-sectional shape of the second reflective portion P2, the third side P2S3 closest to the third reflective portion P3 may form a second transmissive surface.

The second reflective portion P2 may include a plurality of reflective surfaces. For example, the second side P2S2 and the third side P2S3 of the second reflective portion P2 may form a first reflective surface and a second reflective surface, respectively. In detail, the third side P2S3 may form a first reflective surface reflecting light incident through the first side P2S1, and the second side P2S3 may form a second reflective surface for re-reflecting light reflected from the third side P2S3 to the third side P2S3.

That is, in the second reflective portion P2, according to the present embodiment, the first side P2S1 may form a first transmissive surface, the second side P2S2 may form a second reflective surface, and the third side P2S3 may form a second transmissive surface and a first reflective surface.

A cross-section of the third reflective portion P3 may be configured as a triangle having three sides. For example, a cross-sectional shape of the third reflective portion P3 may be a triangle including a first side P3S1, a third side P3S2, and a third side P3S3.

The third reflective portion P3 is configured to form an image with light exiting the second reflective portion P2 on the imaging plane IP or reflect the light. To this end, the third reflective portion P3 may include a plurality of reflective surfaces and a plurality of transmissive surfaces. In detail, the third reflective portion P3 may include two reflective surfaces and two transmissive surfaces.

The third reflective portion P3 may include a plurality of transmissive surfaces. For example, the first side P3S1 and the second side P3S2 of the third reflective portion P3 may form a first transmissive surface and a second transmissive surface, respectively. In detail, in the cross-sectional shape of the third reflective portion P3, the first side P3S1 closest to the second reflective portion P2 may form a first transmissive surface, and in the cross-sectional shape of the third reflective portion P3, the second side P3S2 closest to the imaging plane IP may form a second transmissive surface.

The third reflective portion P3 may include a plurality of reflective surfaces. For example, each of the first side P3S1, the second side P3S2, and the third side P3S3 of the third reflective portion P3 may form a reflective surface. In detail, the second side P3S2 may form a first reflective surface reflecting light incident through the first side P3S1 to the first side P3S1, the first side P3S1 may form a second reflective surface totally reflecting light reflected from the second side P3S2 to the third side P3S3, and the third side P3S3 may form a third reflective surface reflecting incident light to an imaging plane.

That is, in the third reflective portion P3, according to the present embodiment, the first side P3S1 may form a first transmissive surface and a second reflective surface, the second side P3S2 may form a first reflective surface and a second transmissive surface, and the third side P3S3 may form a third reflective surface.

The second reflective portion P2 and the third reflective portion P3 may be configured to establish a predetermined geometric relationship. For example, the third side P2S3 of the second reflective portion P2 may be formed substantially parallel to the first side P3S1 of the third reflective portion P3. As another example, the second side P2S2 of the second reflective portion P2 may be formed substantially parallel to the second side P3S2 of the third reflective portion P3. As another example, an included angle θ1 between the second side P2S2 and the third side P2S3 of the second reflective portion P2 may be substantially the same as an included angle θ2 between the first side P3S1 and the second side P3S2 of the third reflective portion P3.

The second reflective portion P2 and the third reflective portion P3 may be disposed with a predetermined interval therebetween. However, the second reflective portion P2 and the third reflective portion P3 are not necessarily spaced apart from each other. For example, one surface of the second reflective portion P2 and one surface of the third reflective portion P3 may be disposed to be in contact with each other.

The imaging lens system 400 configured as described above may secure an optical path of a significant length (or distance) through the second reflective portion P2 and the third reflective portion P3, so that the imaging lens system 400 may be employed in implementing a high-performance telephoto camera module. In addition, in the imaging lens system 400, according to the present embodiment, since the first lens 410, the second lens 420, the first reflective portion P1, the third lens 430, the second reflective portion P2, and the third reflective portion P3 may be integrated into a limited space, the imaging lens system 400 may be mounted on a relatively small or ultra-thin terminal.

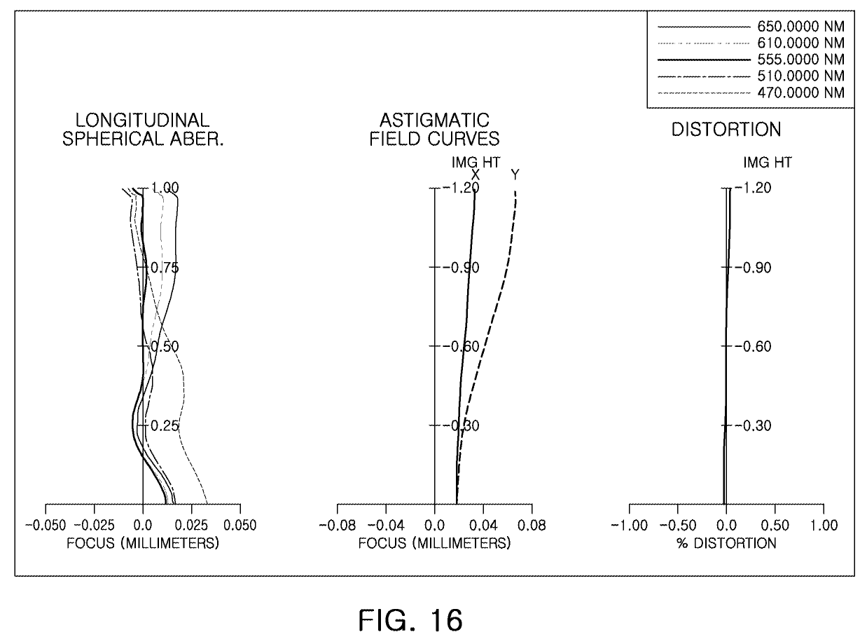

The optical imaging system 400 configured as described above may exhibit aberration characteristics of the form illustrated in FIG. 16. Tables 7 and 8 show lens characteristics and aspheric values of the imaging lens system according to the present embodiment.

Table 7

| Surface No. | Configuration | Radius of curvature | Thickness/di stance | Refractive index | Abbe’s No. | Focal length |
|---|---|---|---|---|---|---|
| S1 | First lens | 11.056 | 2.000 | 1.537 | 55.7 | 17.0716 |
| S2 | | -50.158 | 0.100 | | | |
| S3 | Second lens | 27.480 | 0.800 | 1.677 | 19.2 | -48.8552 |
| S4 | | 14.833 | 1.000 | | | |
| S5 | | Infinity | 0.000 | | | |
| S6 | First reflective portion | Infinity | 3.000 | 1.518 | 64.2 | |
| S7 | | Infinity | 3.000 | 1.518 | 64.2 | |
| S8 | | Infinity | 1.400 | | | |
| S9 | Third lens | -36.453 | 0.800 | 1.537 | 55.7 | -113.2090 |
| S10 | | -22.610 | 0.400 | | | |
| S11 | Second reflective portion | Infinity | 4.000 | 1.518 | 64.2 | |
| S12 | | Infinity | 4.000 | 1.518 | 64.2 | |
| S13 | | Infinity | 2.000 | 1.518 | 64.2 | |
| S14 | | Infinity | 0.500 | | | |
| S15 | Third reflective portion | Infinity | 1.600 | 1.518 | 64.2 | |
| S16 | | Infinity | 3.000 | 1.518 | 64.2 | |
| S17 | | Infinity | 6.000 | 1.518 | 64.2 | |
| S18 | | Infinity | 2.600 | 1.518 | 64.2 | |
| S19 | | Infinity | 0.200 | | | |
| S20 | Filter | Infinity | 0.210 | 1.518 | 64.2 | |
| S21 | | Infinity | 0.475 | | | |
| S22 | Imaging plane | Infinity | -0.02 | | | |

Table 8

| Surface No. | S1 | S2 | S3 | S4 | S9 | S10 |
|---|---|---|---|---|---|---|
| K | 0 | 0 | 3.176E+01 | 1.320E+00 | 0 | 1.729E+01 |
| A | 0 | 0 | 2.834E-02 | 9.351E-03 | 0 | 1.834E-03 |
| B | 0 | 0 | -2.453E-03 | 3.441E-03 | 0 | -6.069E-04 |
| C | 0 | 0 | 1.570E-03 | 8.699E-04 | 0 | 3.451E-04 |
| D | 0 | 0 | 1.608E-03 | 1.564E-03 | 0 | -1.466E-04 |
| E | 0 | 0 | -2.680E-04 | 2.375E-04 | 0 | 1.272E-04 |
| F | 0 | 0 | -1.804E-04 | -4.904E-05 | 0 | -9.930E-05 |
| G | 0 | 0 | -1.569E-05 | -2.252E-06 | 0 | 1.081E-05 |
| H | 0 | 0 | 0 | 0 | 0 | 0 |
| J | 0 | 0 | 0 | 0 | 0 | 0 |

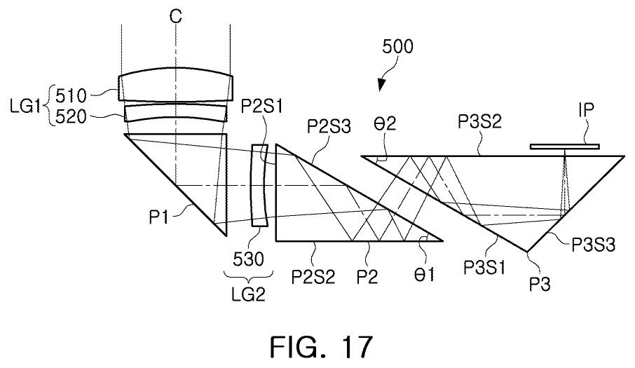

Next, an imaging lens system according to a fifth embodiment will be described with reference to FIG. 17.

An imaging lens system 500 according to the present embodiment includes a first lens group LG1, a first reflective portion P1, a second lens group LG2, a second reflective portion P2, and a third reflective portion P3 sequentially arranged from an object side. However, the configuration of the imaging lens system 500 is not limited to the aforementioned members.

The first lens group LG1 may include a plurality of lenses. For example, the first lens group LG1 may include a first lens 510 and a second lens 520. However, the configuration of the first lens group LG1 is not limited to the first lens 510 and the second lens 520. The first lens 510 and the second lens 520 may be sequentially disposed from the object side. The first lens 510 and the second lens 520 may be disposed with a predetermined interval therebetween. For example, an image-side surface of the first lens 510 may be disposed so as not to contact the object-side surface of the second lens 520.

Next, the characteristics of the first lens 510 and the second lens 520 will be described.

The first lens 510 has refractive power. For example, the first lens 510 may have positive refractive power. The first lens 510 has a convex object-side surface and a convex image-side surface. The first lens 510 may include a spherical surface. For example, both the object-side surface and the image-side surface of the first lens 510 may be formed of a spherical surface.

The second lens 520 has refractive power. For example, the second lens 520 may have negative refractive power. The second lens 520 has a convex object-side surface and a concave image-side surface. The second lens 520 may include an aspherical surface. For example, both the object-side surface and the image-side surface of the second lens 520 may be formed of an aspherical surface.

The first reflective portion P1 may be configured to totally reflect light incident through the first lens group LG1 to the second lens group LG2. For example, the first reflective portion P1 may be configured to reflect light incident through the first lens group LG1 in a substantially 90 degree direction.

The second lens group LG2 may include one or more lenses. For example, the second lens group LG2 may include a third lens 530. The third lens 530 has refractive power. For example, the third lens 530 may have negative refractive power. The third lens 530 has a convex object-side surface and a concave image-side surface. The third lens 530 may include an aspherical surface. For example, the image-side surface of the third lens 530 may be formed as an aspherical surface.

The second reflective portion P2 and the third reflective portion P3 may be disposed between the third lens 530 and the imaging plane IP. The second reflective portion P2 and the third reflective portion P3 may be configured to reduce an external distance from the image-side surface of the third lens 530 to the imaging plane IP. In detail, the second reflective portion P2 and the third reflective portion P3 may reduce an external distance or size from the image-side surface of the third lens 530 to the imaging plane, without substantially changing an optical path length (or BFL) from the image-side surface of the third lens 530 to the imaging plane. Therefore, the optical imaging system 500, according to the present embodiment, may be mounted on a relatively small or thin terminal as it is optically designed. The second reflective portion P2 and the third reflective portion P3 may be configured in a prism shape. However, the shapes of the second reflective portion P2 and the third reflective portion P3 are not limited to the prism.

Next, the shapes of the second reflective portion P2 and the third reflective portion P3 will be described.

A cross-section of the second reflective portion P2 may be configured as a triangle having three sides. For example, the cross-sectional shape of the second reflective portion P2 may be a triangle, including a first side P2S1, a second side P2S2, and a third side P2S3.

The second reflective portion P2 is configured to refract light incident from the third lens 530 to the third reflective portion P3. To this end, the second reflective portion P2 may include a plurality of reflective surfaces and a plurality of transmissive surfaces. In detail, the second reflective portion P2 may include two reflective surfaces and two transmissive surfaces.

The second reflective portion P2 may include a plurality of transmissive surfaces. For example, the first side P2S1 and the third side P2S3 of the second reflective portion P2 may form a first transmissive surface and a second transmissive surface, respectively. In detail, in the cross-sectional shape of the second reflective portion P2, the first side P2S1 closest to the third lens 530 may form a first transmissive surface, and in the cross-sectional shape of the second reflective portion P2, the third side P2S3 closest to the third reflective portion P3 may form a second transmissive surface.

The second reflective portion P2 may include a plurality of reflective surfaces. For example, the second side P2S2 and the third side P2S3 of the second reflective portion P2 may form a first reflective surface and a second reflective surface, respectively. In detail, the third side P2S3 may form a first reflective surface reflecting light incident through the first side P2S1, and the second side P2S3 may form a second reflective surface for re-reflecting light reflected from the third side P2S3 to the third side P2S3.

That is, in the second reflective portion P2, according to the present embodiment, the first side P2S1 may form a first transmissive surface, the second side P2S2 may form a second reflective surface, and the third side P2S3 may form a second transmissive surface and a first reflective surface.

A cross-section of the third reflective portion P3 may be configured as a triangle having three sides. For example, a cross-sectional shape of the third reflective portion P3 may be a triangle including a first side P3S1, a third side P3S2, and a third side P3S3.

The third reflective portion P3 is configured to form an image with light exiting the second reflective portion P2 on the imaging plane IP or reflect the light. To this end, the third reflective portion P3 may include a plurality of reflective surfaces and a plurality of transmissive surfaces. In detail, the third reflective portion P3 may include two reflective surfaces and two transmissive surfaces.

The third reflective portion P3 may include a plurality of transmissive surfaces. For example, the first side P3S1 and the second side P3S2 of the third reflective portion P3 may form a first transmissive surface and a second transmissive surface, respectively. In detail, in the cross-sectional shape of the third reflective portion P3, the first side P3S1 closest to the second reflective portion P2 may form a first transmissive surface, and in the cross-sectional shape of the third reflective portion P3, the second side P3S2 closest to the imaging plane IP may form a second transmissive surface.

The third reflective portion P3 may include a plurality of reflective surfaces. For example, each of the first side P3S1, the second side P3S2, and the third side P3S3 of the third reflective portion P3 may form a reflective surface. In detail, the second side P3S2 may form a first reflective surface reflecting light incident through the first side P3S1 to the first side P3S1, the first side P3S1 may form a second reflective surface totally reflecting light reflected from the second side P3S2 to the third side P3S3, and the third side P3S3 may form a third reflective surface reflecting incident light to an imaging plane.

That is, in the third reflective portion P3, according to the present embodiment, the first side P3S1 may form a first transmissive surface and a second reflective surface, the second side P3S2 may form a first reflective surface and a second transmissive surface, and the third side P3S3 may form a third reflective surface.

The second reflective portion P2 and the third reflective portion P3 may be configured to establish a predetermined geometric relationship. For example, the third side P2S3 of the second reflective portion P2 may be formed substantially parallel to the first side P3S1 of the third reflective portion P3. As another example, the second side P2S2 of the second reflective portion P2 may be formed substantially parallel to the second side P3S2 of the third reflective portion P3. As another example, an included angle θ1 between the second side P2S2 and the third side P2S3 of the second reflective portion P2 may be substantially the same as an included angle θ2 between the first side P3S1 and the second side P3S2 of the third reflective portion P3.

The second reflective portion P2 and the third reflective portion P3 may be disposed with a predetermined interval therebetween. However, the second reflective portion P2 and the third reflective portion P3 are not necessarily spaced apart from each other. For example, one surface of the second reflective portion P2 and one surface of the third reflective portion P3 may be disposed to be in contact with each other.

The imaging lens system 500 configured as described above may secure an optical path of a significant length (or distance) through the second reflective portion P2 and the third reflective portion P3, so that the imaging lens system 500 may be employed in implementing a high-performance telephoto camera module. In addition, in the imaging lens system 500, according to the present embodiment, since the first lens 510, the second lens 520, the first reflective portion P1, the third lens 530, the second reflective portion P2, and the third reflective portion P3 may be integrated into a limited space, the imaging lens system 500 may be mounted on a relatively small or ultra-thin terminal.

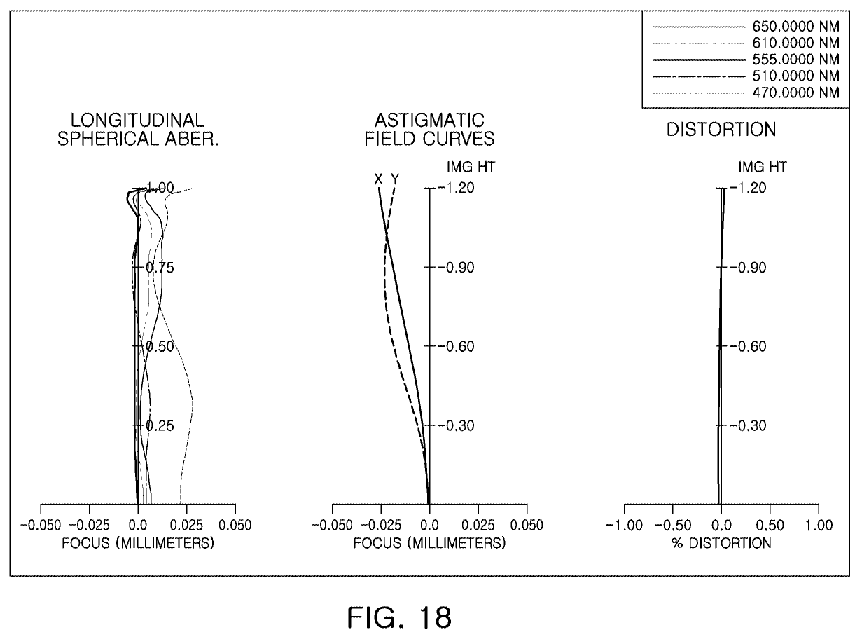

The optical imaging system 500 configured as described above may exhibit aberration characteristics of the form illustrated in FIG. 18. Tables 9 and 10 show lens characteristics and aspheric values of the imaging lens system according to the present embodiment.

Table 9

| Surface No. | Configuration | Radius of curvature | Thickness/di stance | Refractive index | Abbe’s No. | Focal length |
|---|---|---|---|---|---|---|
| S1 | First lens | 6.603 | 1.200 | 1.537 | 55.7 | 10.2873 |
| S2 | | -31.588 | 0.060 | | | |
| S3 | Second lens | 16.634 | 0.480 | 1.677 | 19.2 | -31.6702 |
| S4 | | 9.257 | 0.600 | | | |
| S5 | | Infinity | 0.000 | | | |
| S6 | First reflective portion | Infinity | 1.800 | 1.518 | 64.2 | |
| S7 | | Infinity | 1.800 | 1.518 | 64.2 | |
| S8 | | Infinity | 0.840 | | | |
| S9 | Third lens | -17.2853915 | 0.480 | 1.537 | 55.7 | -33.0163 |
| S10 | | -8.666 | 0.400 | | | |
| S11 | Second reflective portion | Infinity | 2.500 | 1.518 | 64.2 | |
| S12 | | Infinity | 2.300 | 1.518 | 64.2 | |
| S13 | | Infinity | 2.300 | 1.518 | 64.2 | |
| S14 | | Infinity | 0.000 | | | |
| S15 | Third reflective portion | Infinity | 1.200 | 1.518 | 64.2 | |
| S16 | | Infinity | 2.400 | 1.518 | 64.2 | |
| S17 | | Infinity | 3.600 | 1.518 | 64.2 | |
| S18 | | Infinity | 2.040 | 1.518 | 64.2 | |
| S19 | | Infinity | 0.281 | | | |
| S20 | Imaging plane | Infinity | 0.000 | | | |

Table 10

| Surface No. | S1 | S2 | S3 | S4 | S9 | S10 |
|---|---|---|---|---|---|---|
| K | 0 | 0 | 2.946E+01 | 1.506E+00 | 0 | 7.453E+00 |
| A | 0 | 0 | 1.963E-02 | 5.278E-03 | 0 | -1.637E-03 |
| B | 0 | 0 | -2.596E-03 | 2.418E-03 | 0 | 5.417E-04 |
| C | 0 | 0 | 6.479E-04 | -2.232E-04 | 0 | -2.707E-04 |
| D | 0 | 0 | 1.047E-03 | 8.320E-04 | 0 | 4.196E-05 |
| E | 0 | 0 | -2.255E-04 | 3.574E-04 | 0 | 7.355E-05 |
| F | 0 | 0 | -2.017E-04 | -3.492E-04 | 0 | -1.660E-04 |
| G | 0 | 0 | -2.380E-06 | 1.385E-04 | 0 | -1.010E-04 |
| H | 0 | 0 | 0 | 0 | 0 | 0 |
| J | 0 | 0 | 0 | 0 | 0 | 0 |

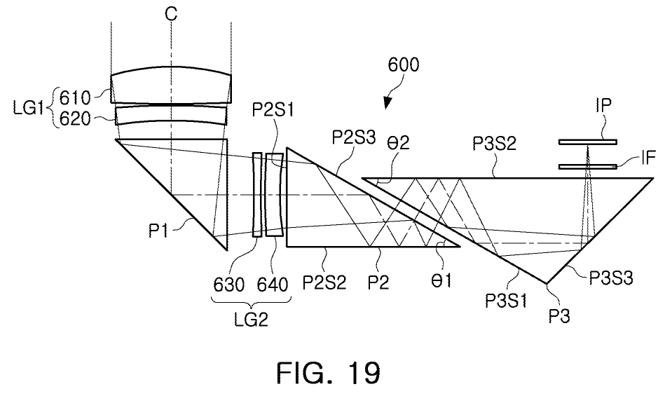

Next, an imaging lens system according to a sixth embodiment will be described with reference to FIG. 19.

An imaging lens system 600, according to the present embodiment, includes a first lens group LG1, a first reflective portion P1, a second lens group LG2, a second reflective portion P2, and a third reflective portion P3 sequentially arranged from an object side. However, the configuration of the imaging lens system 600 is not limited to the aforementioned members.

The first lens group LG1 may include a plurality of lenses. For example, the first lens group LG1 may include a first lens 610 and a second lens 620. However, the configuration of the first lens group LG1 is not limited to the first lens 610 and the second lens 620. The first lens 610 and the second lens 620 may be sequentially disposed from the object side. The first lens 610 and the second lens 620 may be disposed with a predetermined interval therebetween. For example, an image-side surface of the first lens 610 may be disposed not to contact with the object-side surface of the second lens 620.

Next, the characteristics of the first lens 610 and the second lens 620 will be described.

The first lens 610 has refractive power. For example, the first lens 610 may have positive refractive power. The first lens 610 has a convex object-side surface and a convex image-side surface. The first lens 610 may include a spherical surface. For example, both the object-side surface and the image-side surface of the first lens 610 may be formed of a spherical surface.

The second lens 620 has refractive power. For example, the second lens 620 may have negative refractive power. The second lens 620 has a convex object-side surface and a concave image-side surface. The second lens 620 may include an aspherical surface. For example, both the object-side surface and the image-side surface of the second lens 620 may be formed of an aspherical surface.

The first reflective portion P1 may be configured to totally reflect light incident through the first lens group LG1 to the second lens group LG2. For example, the first reflective portion P1 may be configured to reflect light incident through the first lens group LG1 in a substantially 90 degree direction.

The second lens group LG2 may include two lenses. For example, the second lens group LG2 may include a third lens 630 and a fourth lens 640. The third lens 630 has refractive power. For example, the third lens 630 may have negative refractive power. The third lens 630 has a concave object-side surface and a concave image-side surface. The third lens 630 may include a spherical surface. For example, both the object-side surface and the image-side surface of the third lens 630 may be formed to have a spherical shape. The fourth lens 640 has refractive power. For example, the fourth lens 640 may have negative refractive power. The fourth lens 640 has a convex object-side surface and a concave image-side surface. The fourth lens 640 may include an aspherical surface. For example, the image-side surface of the fourth lens 640 may be formed as an aspherical surface.

The second reflective portion P2 and the third reflective portion P3 may be disposed between the third lens 630 and the imaging plane IP. The second reflective portion P2 and the third reflective portion P3 may be configured to reduce an external distance from the image-side surface of the third lens 630 to the imaging plane IP. In detail, the second reflective portion P2 and the third reflective portion P3 may reduce an external distance or size from the image-side surface of the third lens 630 to the imaging plane, without substantially changing an optical path length (or BFL) from the image-side surface of the third lens 630 to the imaging plane. Therefore, the optical imaging system 600, according to the present embodiment, may be mounted on a relatively small or thin terminal as it is optically designed. The second reflective portion P2 and the third reflective portion P3 may be configured in a prism shape. However, the shapes of the second reflective portion P2 and the third reflective portion P3 are not limited to the prism.

Next, the shapes of the second reflective portion P2 and the third reflective portion P3 will be described.

A cross-section of the second reflective portion P2 may be configured as a triangle having three sides. For example, the cross-sectional shape of the second reflective portion P2 may be a triangle, including a first side P2S1, a second side P2S2, and a third side P2S3.

The second reflective portion P2 is configured to refract light incident from the third lens 630 to the third reflective portion P3. To this end, the second reflective portion P2 may include a plurality of reflective surfaces and a plurality of transmissive surfaces. In detail, the second reflective portion P2 may include two reflective surfaces and two transmissive surfaces.

The second reflective portion P2 may include a plurality of transmissive surfaces. For example, the first side P2S1 and the third side P2S3 of the second reflective portion P2 may form a first transmissive surface and a second transmissive surface, respectively. In detail, in the cross-sectional shape of the second reflective portion P2, the first side P2S1 closest to the third lens 630 may form a first transmissive surface, and in the cross-sectional shape of the second reflective portion P2, the third side P2S3 closest to the third reflective portion P3 may form a second transmissive surface.

The second reflective portion P2 may include a plurality of reflective surfaces. For example, the second side P2S2 and the third side P2S3 of the second reflective portion P2 may form a first reflective surface and a second reflective surface, respectively. In detail, the third side P2S3 may form a first reflective surface reflecting light incident through the first side P2S1, and the second side P2S3 may form a second reflective surface for re-reflecting light reflected from the third side P2S3 to the third side P2S3.

That is, in the second reflective portion P2, according to the present embodiment, the first side P2S1 may form a first transmissive surface, the second side P2S2 may form a second reflective surface, and the third side P2S3 may form a second transmissive surface and a first reflective surface.

A cross-section of the third reflective portion P3 may be configured as a triangle having three sides. For example, a cross-sectional shape of the third reflective portion P3 may be a triangle including a first side P3S1, a third side P3S2, and a third side P3S3.

The third reflective portion P3 is configured to form an image with light exiting the second reflective portion P2 on the imaging plane IP or reflect the light. To this end, the third reflective portion P3 may include a plurality of reflective surfaces and a plurality of transmissive surfaces. In detail, the third reflective portion P3 may include two reflective surfaces and two transmissive surfaces.

The third reflective portion P3 may include a plurality of transmissive surfaces. For example, the first side P3S1 and the second side P3S2 of the third reflective portion P3 may form a first transmissive surface and a second transmissive surface, respectively. In detail, in the cross-sectional shape of the third reflective portion P3, the first side P3S1 closest to the second reflective portion P2 may form a first transmissive surface, and in the cross-sectional shape of the third reflective portion P3, the second side P3S2 closest to the imaging plane IP may form a second transmissive surface.

The third reflective portion P3 may include a plurality of reflective surfaces. For example, each of the first side P3S1, the second side P3S2, and the third side P3S3 of the third reflective portion P3 may form a reflective surface. In detail, the second side P3S2 may form a first reflective surface reflecting light incident through the first side P3S1 to the first side P3S1, the first side P3S1 may form a second reflective surface totally reflecting light reflected from the second side P3S2 to the third side P3S3, and the third side P3S3 may form a third reflective surface reflecting incident light to an imaging plane.

That is, in the third reflective portion P3, according to the present embodiment, the first side P3S1 may form a first transmissive surface and a second reflective surface, the second side P3S2 may form a first reflective surface and a second transmissive surface, and the third side P3S3 may form a third reflective surface.

The second reflective portion P2 and the third reflective portion P3 may be configured to establish a predetermined geometric relationship. For example, the third side P2S3 of the second reflective portion P2 may be formed substantially parallel to the first side P3S1 of the third reflective portion P3. As another example, the second side P2S2 of the second reflective portion P2 may be formed substantially parallel to the second side P3S2 of the third reflective portion P3. As another example, an included angle θ1 between the second side P2S2 and the third side P2S3 of the second reflective portion P2 may be substantially the same as an included angle θ2 between the first side P3S1 and the second side P3S2 of the third reflective portion P3.

The second reflective portion P2 and the third reflective portion P3 may be disposed with a predetermined interval therebetween. However, the second reflective portion P2 and the third reflective portion P3 are not necessarily spaced apart from each other. For example, one surface of the second reflective portion P2 and one surface of the third reflective portion P3 may be disposed to be in contact with each other.

The imaging lens system 600 configured as described above may secure an optical path of a significant length (or distance) through the second reflective portion P2 and the third reflective portion P3, so that the imaging lens system 600 may be employed in implementing a high-performance telephoto camera module. In addition, in the imaging lens system 600, according to the present embodiment, since the first lens 610, the second lens 620, the first reflective portion P1, the third lens 630, the fourth lens 640, the second reflective portion P2, and the third reflective portion P3 may be integrated into a limited space, the imaging lens system 600 may be mounted on a relatively small or ultra-thin terminal.

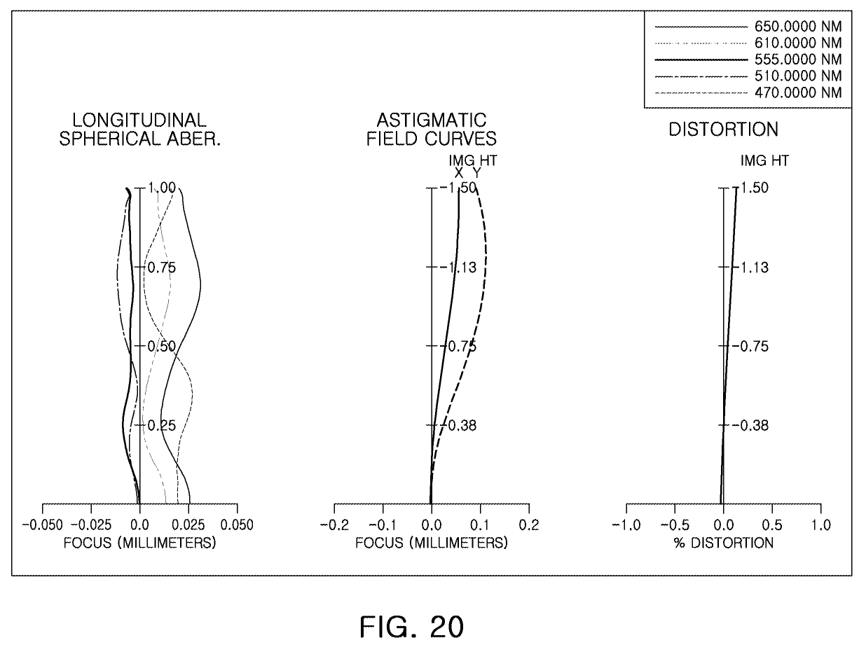

The optical imaging system 600 configured as described above may exhibit aberration characteristics of the form illustrated in FIG. 20. Tables 11 and 12 show lens characteristics and aspheric values of the imaging lens system according to the present embodiment.

Table 11

| Surface No. | Configuration | Radius of curvature | Thickness/di stance | Refractive index | Abbe’s No. | Focal length |
|---|---|---|---|---|---|---|
| S1 | First lens | 10.808 | 2.000 | 1.537 | 55.7 | 17.1408 |
| S2 | | -57.895 | 0.100 | | | |
| S3 | Second lens | 28.033 | 0.800 | 1.677 | 19.2 | -64.2269 |
| S4 | | 16.847 | 1.000 | | | |
| S5 | | Infinity | 0.000 | | | |
| S6 | First reflective portion | Infinity | 3.000 | 1.518 | 64.2 | |
| S7 | | Infinity | 3.000 | 1.518 | 64.2 | |
| S8 | | Infinity | 1.400 | | | |
| S9 | Third lens | 129.079544 | 0.400 | 1.645 | 23.5 | -117.0044 |
| S10 | | -181.631 | 0.200 | | | |
| S11 | Fourth lens | 27.3053294 | 0.800 | 1.537 | 55.7 | -52.1855 |
| S12 | | 13.6857342 | 0.400 | | | |
| S13 | Second reflective portion | Infinity | 4.400 | 1.518 | 64.2 | |
| S14 | | Infinity | 3.200 | 1.518 | 64.2 | |
| S15 | | Infinity | 1.600 | 1.518 | 64.2 | |
| S16 | | Infinity | 0.600 | | | |
| S17 | Third reflective portion | Infinity | 2.000 | 1.518 | 64.2 | |
| S18 | | Infinity | 4.000 | 1.518 | 64.2 | |
| S19 | | Infinity | 6.000 | 1.518 | 64.2 | |
| S20 | | Infinity | 3.500 | 1.518 | 64.2 | |
| S21 | | Infinity | 0.500 | | | |
| S22 | Filter | Infinity | 0.210 | 1.518 | 64.2 | |
| S23 | | Infinity | 1.141 | | | |
| S24 | Imaging plane | Infinity | 0.000 | | | |

Table 12

| Surface No. | S1 | S2 | S3 | S4 | S9 | S10 | S11 | S12 |
|---|---|---|---|---|---|---|---|---|
| K | 0 | 0 | 2.879E+01 | 1.452E+00 | 0 | 0 | 0 | 1.035E+01 |
| A | 0 | 0 | 3.432E-02 | 7.038E-03 | 0 | 0 | 0 | -3.764E-03 |
| B | 0 | 0 | -4.297E-03 | 4.538E-03 | 0 | 0 | 0 | 1.158E-03 |
| C | 0 | 0 | 1.513E-03 | 1.707E-04 | 0 | 0 | 0 | -3.614E-04 |
| D | 0 | 0 | 7.904E-04 | 7.891E-04 | 0 | 0 | 0 | 3.850E-05 |
| E | 0 | 0 | 4.802E-04 | 9.102E-04 | 0 | 0 | 0 | 9.442E-06 |
| F | 0 | 0 | -7.809E-04 | -4.432E-04 | 0 | 0 | 0 | 2.737E-05 |
| G | 0 | 0 | -1.845E-04 | -8.055E-06 | 0 | 0 | 0 | 1.902E-05 |
| H | 0 | 0 | 0 | 0 | 0 | 0 | 0 | 0 |
| J | 0 | 0 | 0 | 0 | 0 | 0 | 0 | 0 |

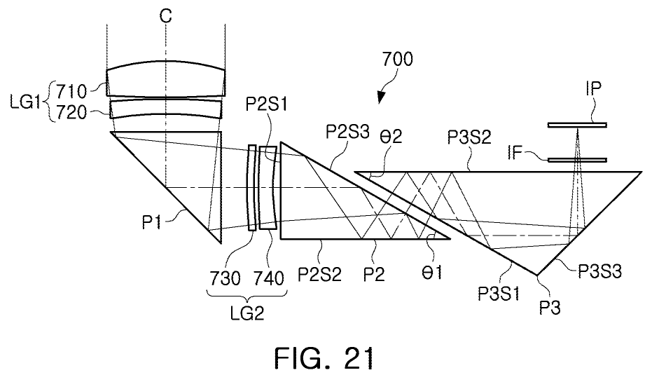

Next, an imaging lens system according to a seventh embodiment will be described with reference to FIG. 21.

An imaging lens system 700, according to the present embodiment, includes a first lens group LG1, a first reflective portion P1, a second lens group LG2, a second reflective portion P2, and a third reflective portion P3 sequentially arranged from an object side. However, the configuration of the imaging lens system 700 is not limited to the aforementioned members.

The first lens group LG1 may include a plurality of lenses. For example, the first lens group LG1 may include a first lens 710 and a second lens 720. However, the configuration of the first lens group LG1 is not limited to the first lens 710 and the second lens 720. The first lens 710 and the second lens 720 may be sequentially disposed from the object side. The first lens 710 and the second lens 720 may be disposed with a predetermined interval therebetween. For example, an image-side surface of the first lens 710 may be disposed not to contact with the object-side surface of the second lens 720.

Next, the characteristics of the first lens 710 and the second lens 720 will be described.

The first lens 710 has refractive power. For example, the first lens 710 may have positive refractive power. The first lens 710 has a convex object-side surface and a convex image-side surface. The first lens 710 may include a spherical surface. For example, both the object-side surface and the image-side surface of the first lens 710 may be formed of a spherical surface.

The second lens 720 has refractive power. For example, the second lens 720 may have negative refractive power. The second lens 720 has a convex object-side surface and a concave image-side surface. The second lens 720 may include an aspherical surface. For example, both the object-side surface and the image-side surface of the second lens 720 may be formed of an aspherical surface.

The first reflective portion P1 may be configured to totally reflect light incident through the first lens group LG1 to the second lens group LG2. For example, the first reflective portion P1 may be configured to reflect light incident through the first lens group LG1 in a substantially 90 degree direction.

The second lens group LG2 may include two lenses. For example, the second lens group LG2 may include a third lens 730 and a fourth lens 740. The third lens 730 has refractive power. For example, the third lens 730 may have negative refractive power. The third lens 730 has a concave object-side surface and a concave image-side surface. The third lens 730 may include a spherical surface. For example, both the object-side surface and the image-side surface of the third lens 730 may be formed to have a spherical shape. The fourth lens 740 has refractive power. For example, the fourth lens 740 may have negative refractive power. The fourth lens 740 has a convex object-side surface and a concave image-side surface. The fourth lens 740 may include an aspherical surface. For example, the image-side surface of the fourth lens 740 may be formed as an aspherical surface.

The second reflective portion P2 and the third reflective portion P3 may be disposed between the third lens 730 and the imaging plane IP. The second reflective portion P2 and the third reflective portion P3 may be configured to reduce an external distance from the image-side surface of the third lens 730 to the imaging plane IP. In detail, the second reflective portion P2 and the third reflective portion P3 may reduce an external distance or size from the image-side surface of the third lens 730 to the imaging plane, without substantially changing an optical path length (or BFL) from the image-side surface of the third lens 730 to the imaging plane. Therefore, the optical imaging system 700, according to the present embodiment, may be mounted on a relatively small or thin terminal as it is optically designed. The second reflective portion P2 and the third reflective portion P3 may be configured in a prism shape. However, the shapes of the second reflective portion P2 and the third reflective portion P3 are not limited to the prism.

Next, the shapes of the second reflective portion P2 and the third reflective portion P3 will be described.

A cross-section of the second reflective portion P2 may be configured as a triangle having three sides. For example, the cross-sectional shape of the second reflective portion P2 may be a triangle, including a first side P2S1, a second side P2S2, and a third side P2S3.

The second reflective portion P2 is configured to refract light incident from the third lens 730 to the third reflective portion P3. To this end, the second reflective portion P2 may include a plurality of reflective surfaces and a plurality of transmissive surfaces. In detail, the second reflective portion P2 may include two reflective surfaces and two transmissive surfaces.

The second reflective portion P2 may include a plurality of transmissive surfaces. For example, the first side P2S1 and the third side P2S3 of the second reflective portion P2 may form a first transmissive surface and a second transmissive surface, respectively. In detail, in the cross-sectional shape of the second reflective portion P2, the first side P2S1 closest to the third lens 730 may form a first transmissive surface, and in the cross-sectional shape of the second reflective portion P2, the third side P2S3 closest to the third reflective portion P3 may form a second transmissive surface.

The second reflective portion P2 may include a plurality of reflective surfaces. For example, the second side P2S2 and the third side P2S3 of the second reflective portion P2 may form a first reflective surface and a second reflective surface, respectively. In detail, the third side P2S3 may form a first reflective surface reflecting light incident through the first side P2S1, and the second side P2S3 may form a second reflective surface for re-reflecting light reflected from the third side P2S3 to the third side P2S3.

That is, in the second reflective portion P2 according to the present embodiment, the first side P2S1 may form a first transmissive surface, the second side P2S2 may form a second reflective surface, and the third side P2S3 may form a second transmissive surface and a first reflective surface.

A cross-section of the third reflective portion P3 may be configured as a triangle having three sides. For example, a cross-sectional shape of the third reflective portion P3 may be a triangle including a first side P3S1, a third side P3S2, and a third side P3S3.

The third reflective portion P3 is configured to form an image with light exiting the second reflective portion P2 on the imaging plane IP or reflect the light. To this end, the third reflective portion P3 may include a plurality of reflective surfaces and a plurality of transmissive surfaces. In detail, the third reflective portion P3 may include two reflective surfaces and two transmissive surfaces.

The third reflective portion P3 may include a plurality of transmissive surfaces. For example, the first side P3S1 and the second side P3S2 of the third reflective portion P3 may form a first transmissive surface and a second transmissive surface, respectively. In detail, in the cross-sectional shape of the third reflective portion P3, the first side P3S1 closest to the second reflective portion P2 may form a first transmissive surface, and in the cross-sectional shape of the third reflective portion P3, the second side P3S2 closest to the imaging plane IP may form a second transmissive surface.

The third reflective portion P3 may include a plurality of reflective surfaces. For example, each of the first side P3S1, the second side P3S2, and the third side P3S3 of the third reflective portion P3 may form a reflective surface. In detail, the second side P3S2 may form a first reflective surface reflecting light incident through the first side P3S1 to the first side P3S1, the first side P3S1 may form a second reflective surface totally reflecting light reflected from the second side P3S2 to the third side P3S3, and the third side P3S3 may form a third reflective surface reflecting incident light to an imaging plane.

That is, in the third reflective portion P3, according to the present embodiment, the first side P3S1 may form a first transmissive surface and a second reflective surface, the second side P3S2 may form a first reflective surface and a second transmissive surface, and the third side P3S3 may form a third reflective surface.

The second reflective portion P2 and the third reflective portion P3 may be configured to establish a predetermined geometric relationship. For example, the third side P2S3 of the second reflective portion P2 may be formed substantially parallel to the first side P3S1 of the third reflective portion P3. As another example, the second side P2S2 of the second reflective portion P2 may be formed substantially parallel to the second side P3S2 of the third reflective portion P3. As another example, an included angle θ1 between the second side P2S2 and the third side P2S3 of the second reflective portion P2 may be substantially the same as an included angle θ2 between the first side P3S1 and the second side P3S2 of the third reflective portion P3.

The second reflective portion P2 and the third reflective portion P3 may be disposed with a predetermined interval therebetween. However, the second reflective portion P2 and the third reflective portion P3 are not necessarily spaced apart from each other. For example, one surface of the second reflective portion P2 and one surface of the third reflective portion P3 may be disposed to be in contact with each other.

The imaging lens system 700 configured as described above may secure an optical path of a significant length (or distance) through the second reflective portion P2 and the third reflective portion P3, so that the imaging lens system 700 may be employed in implementing a high-performance telephoto camera module. In addition, in the imaging lens system 700, according to the present embodiment, since the first lens 710, the second lens 720, the first reflective portion P1, the third lens 730, the fourth lens 740, the second reflective portion P2, and the third reflective portion P3 may be integrated into a limited space, the imaging lens system 700 may be mounted on a relatively small or ultra-thin terminal.

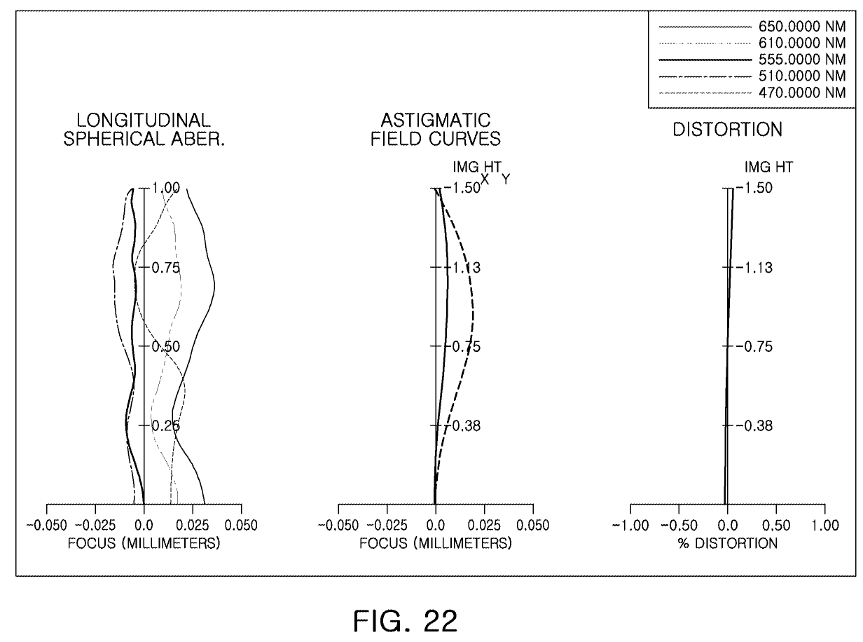

The optical imaging system 700 configured as described above may exhibit aberration characteristics of the form illustrated in FIG. 22. Tables 13 and 14 show lens characteristics and aspheric values of the imaging lens system according to the present embodiment.

Table 13

| Surface No. | Configuration | Radius of curvature | Thickness/di stance | Refractive index | Abbe’s No. | Focal length |
|---|---|---|---|---|---|---|
| S1 | First lens | 10.808 | 2.000 | 1.537 | 55.7 | 17.1312 |
| S2 | | -57.680 | 0.100 | | | |
| S3 | Second lens | 28.097 | 0.800 | 1.677 | 19.2 | -56.1615 |
| S4 | | 15.971 | 1.000 | | | |
| S5 | | Infinity | 0.000 | | | |
| S6 | First reflective portion | Infinity | 3.000 | 1.518 | 64.2 | |
| S7 | | Infinity | 3.000 | 1.518 | 64.2 | |
| S8 | | Infinity | 1.400 | | | |
| S9 | Third lens | -51.4637 | 0.400 | 1.537 | 55.7 | -249.6500 |
| S10 | | -37.083 | 0.200 | | | |
| S11 | Fourth lens | -32.1572 | 0.800 | 1.537 | 55.7 | -48.2648 |
| S12 | | -14.2235 | 0.400 | | | |
| S13 | Second reflective portion | Infinity | 4.400 | 1.518 | 64.2 | |
| S14 | | Infinity | 3.200 | 1.518 | 64.2 | |
| S15 | | Infinity | 1.600 | 1.518 | 64.2 | |
| S16 | | Infinity | 0.600 | | | |
| S17 | Third reflective portion | Infinity | 2.000 | 1.518 | 64.2 | |
| S18 | | Infinity | 4.000 | 1.518 | 64.2 | |
| S19 | | Infinity | 6.000 | 1.518 | 64.2 | |
| S20 | | Infinity | 3.500 | 1.518 | 64.2 | |
| S21 | | Infinity | 0.500 | | | |
| S22 | Filter | Infinity | 0.210 | 1.518 | 64.2 | |
| S23 | | Infinity | 1.682 | | | |
| S24 | Imaging plane | Infinity | 0.000 | | | |

Table 14

| Surface No. | S1 | S2 | S3 | S4 | S9 | S10 | S11 | S12 |
|---|---|---|---|---|---|---|---|---|
| K | 0 | 0 | 2.877E+01 | 1.465E+00 | 0 | 0 | 0 | 1.036E+01 |
| A | 0 | 0 | 3.441E-02 | 6.928E-03 | 0 | 0 | 0 | -3.750E-03 |
| B | 0 | 0 | -4.242E-03 | 4.469E-03 | 0 | 0 | 0 | 1.063E-03 |
| C | 0 | 0 | 1.523E-03 | 1.653E-04 | 0 | 0 | 0 | -3.874E-04 |
| D | 0 | 0 | 7.978E-04 | 7.791E-04 | 0 | 0 | 0 | 2.816E-05 |
| E | 0 | 0 | 4.830E-04 | 9.062E-04 | 0 | 0 | 0 | 8.484E-07 |
| F | 0 | 0 | -7.728E-04 | -4.393E-04 | 0 | 0 | 0 | 1.956E-05 |
| G | 0 | 0 | -1.731E-04 | -7.472E-06 | 0 | 0 | 0 | 2.167E-05 |
| H | 0 | 0 | 0 | 0 | 0 | 0 | 0 | 0 |
| J | 0 | 0 | 0 | 0 | 0 | 0 | 0 | 0 |

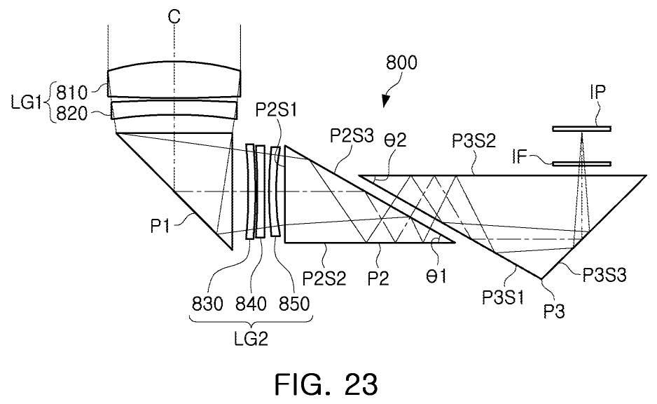

Next, an imaging lens system according to an eighth embodiment will be described with reference to FIG. 23.

An imaging lens system 800, according to the present embodiment, includes a first lens group LG1, a first reflective portion P1, a second lens group LG2, a second reflective portion P2, and a third reflective portion P3 sequentially arranged from an object side. However, the configuration of the imaging lens system 800 is not limited to the aforementioned members.

The first lens group LG1 may include a plurality of lenses. For example, the first lens group LG1 may include a first lens 810 and a second lens 820. However, the configuration of the first lens group LG1 is not limited to the first lens 810 and the second lens 820. The first lens 810 and the second lens 820 may be sequentially disposed from the object side. The first lens 810 and the second lens 820 may be disposed with a predetermined interval therebetween. For example, an image-side surface of the first lens 810 may be disposed not to contact with the object-side surface of the second lens 820.

Next, the characteristics of the first lens 810 and the second lens 820 will be described.

The first lens 810 has refractive power. For example, the first lens 810 may have positive refractive power. The first lens 810 has a convex object-side surface and a convex image-side surface. The first lens 810 may include a spherical surface. For example, both the object-side surface and the image-side surface of the first lens 810 may be formed of a spherical surface.

The second lens 820 has refractive power. For example, the second lens 820 may have negative refractive power. The second lens 820 has a convex object-side surface and a concave image-side surface. The second lens 820 may include an aspherical surface. For example, both the object-side surface and the image-side surface of the second lens 820 may be formed of an aspherical surface.

The first reflective portion P1 may be configured to totally reflect light incident through the first lens group LG1 to the second lens group LG2. For example, the first reflective portion P1 may be configured to reflect light incident through the first lens group LG1 in a substantially 90 degree direction.

The second lens group LG2 may include three lenses. For example, the second lens group LG2 may include a third lens 830, a fourth lens 840, and a fifth lens 850. The third lens 830 has refractive power. For example, the third lens 830 may have negative refractive power. The third lens 830 has a concave object-side surface and a convex image-side surface. The third lens 830 may include a spherical surface. For example, both the object-side surface and the image-side surface of the third lens 830 may be formed as spherical surfaces. The fourth lens 840 has refractive power. For example, the fourth lens 840 may have negative refractive power. The fourth lens 840 has a concave object-side surface and a flat image-side surface. The fourth lens 840 may include a spherical surface. For example, both the object-side surface and the image-side surface of the fourth lens 840 may be formed of a spherical surface. The fifth lens 850 has refractive power. For example, the fifth lens 850 may have negative refractive power. The fifth lens 850 has a convex object-side surface and a concave image-side surface. The fifth lens 850 may include an aspherical surface. For example, the image-side surface of the fifth lens 850 may be formed as an aspherical surface.

The second reflective portion P2 and the third reflective portion P3 may be disposed between the third lens 830 and the imaging plane IP. The second reflective portion P2 and the third reflective portion P3 may be configured to reduce an external distance from the image-side surface of the third lens 830 to the imaging plane IP. In detail, the second reflective portion P2 and the third reflective portion P3 may reduce an external distance or size from the image-side surface of the third lens 830 to the imaging plane, without substantially changing an optical path length (or BFL) from the image-side surface of the third lens 830 to the imaging plane. Therefore, the optical imaging system 800, according to the present embodiment, may be mounted on a relatively small or thin terminal as it is optically designed. The second reflective portion P2 and the third reflective portion P3 may be configured in a prism shape. However, the shapes of the second reflective portion P2 and the third reflective portion P3 are not limited to the prism.

Next, the shapes of the second reflective portion P2 and the third reflective portion P3 will be described.

A cross-section of the second reflective portion P2 may be configured as a triangle having three sides. For example, the cross-sectional shape of the second reflective portion P2 may be a triangle, including a first side P2S1, a second side P2S2, and a third side P2S3.

The second reflective portion P2 is configured to refract light incident from the third lens 830 to the third reflective portion P3. To this end, the second reflective portion P2 may include a plurality of reflective surfaces and a plurality of transmissive surfaces. In detail, the second reflective portion P2 may include two reflective surfaces and two transmissive surfaces.

The second reflective portion P2 may include a plurality of transmissive surfaces. For example, the first side P2S1 and the third side P2S3 of the second reflective portion P2 may form a first transmissive surface and a second transmissive surface, respectively. In detail, in the cross-sectional shape of the second reflective portion P2, the first side P2S1 closest to the third lens 830 may form a first transmissive surface, and in the cross-sectional shape of the second reflective portion P2, the third side P2S3 closest to the third reflective portion P3 may form a second transmissive surface.

The second reflective portion P2 may include a plurality of reflective surfaces. For example, the second side P2S2 and the third side P2S3 of the second reflective portion P2 may form a first reflective surface and a second reflective surface, respectively. In detail, the third side P2S3 may form a first reflective surface reflecting light incident through the first side P2S1, and the second side P2S3 may form a second reflective surface for re-reflecting light reflected from the third side P2S3 to the third side P2S3.

That is, in the second reflective portion P2, according to the present embodiment, the first side P2S1 may form a first transmissive surface, the second side P2S2 may form a second reflective surface, and the third side P2S3 may form a second transmissive surface and a first reflective surface.

A cross-section of the third reflective portion P3 may be configured as a triangle having three sides. For example, a cross-sectional shape of the third reflective portion P3 may be a triangle including a first side P3S1, a third side P3S2, and a third side P3S3.

The third reflective portion P3 is configured to form an image with light exiting the second reflective portion P2 on the imaging plane IP or reflect the light. To this end, the third reflective portion P3 may include a plurality of reflective surfaces and a plurality of transmissive surfaces. In detail, the third reflective portion P3 may include two reflective surfaces and two transmissive surfaces.

The third reflective portion P3 may include a plurality of transmissive surfaces. For example, the first side P3S1 and the second side P3S2 of the third reflective portion P3 may form a first transmissive surface and a second transmissive surface, respectively. In detail, in the cross-sectional shape of the third reflective portion P3, the first side P3S1 closest to the second reflective portion P2 may form a first transmissive surface, and in the cross-sectional shape of the third reflective portion P3, the second side P3S2 closest to the imaging plane IP may form a second transmissive surface.

The third reflective portion P3 may include a plurality of reflective surfaces. For example, each of the first side P3S1, the second side P3S2, and the third side P3S3 of the third reflective portion P3 may form a reflective surface. In detail, the second side P3S2 may form a first reflective surface reflecting light incident through the first side P3S1 to the first side P3S1, the first side P3S1 may form a second reflective surface totally reflecting light reflected from the second side P3S2 to the third side P3S3, and the third side P3S3 may form a third reflective surface reflecting incident light to an imaging plane.

That is, in the third reflective portion P3, according to the present embodiment, the first side P3S1 may form a first transmissive surface and a second reflective surface, the second side P3S2 may form a first reflective surface and a second transmissive surface, and the third side P3S3 may form a third reflective surface.

The second reflective portion P2 and the third reflective portion P3 may be configured to establish a predetermined geometric relationship. For example, the third side P2S3 of the second reflective portion P2 may be formed substantially parallel to the first side P3S1 of the third reflective portion P3. As another example, the second side P2S2 of the second reflective portion P2 may be formed substantially parallel to the second side P3S2 of the third reflective portion P3. As another example, an included angle θ1 between the second side P2S2 and the third side P2S3 of the second reflective portion P2 may be substantially the same as an included angle θ2 between the first side P3S1 and the second side P3S2 of the third reflective portion P3.

The second reflective portion P2 and the third reflective portion P3 may be disposed with a predetermined interval therebetween. However, the second reflective portion P2 and the third reflective portion P3 are not necessarily spaced apart from each other. For example, one surface of the second reflective portion P2 and one surface of the third reflective portion P3 may be disposed to be in contact with each other.

The imaging lens system 800 configured as described above may secure an optical path of a significant length (or distance) through the second reflective portion P2 and the third reflective portion P3, so that the imaging lens system 800 may be employed in implementing a high-performance telephoto camera module. In addition, in the imaging lens system 800, according to the present embodiment, since the first lens 810, the second lens 820, the first reflective portion P1, the third lens 830, the fourth lens 840, the fifth lens 850, the second reflective portion P2, and the third reflective portion P3 may be integrated into a limited space, the imaging lens system 800 may be mounted on a relatively small or ultra-thin terminal.

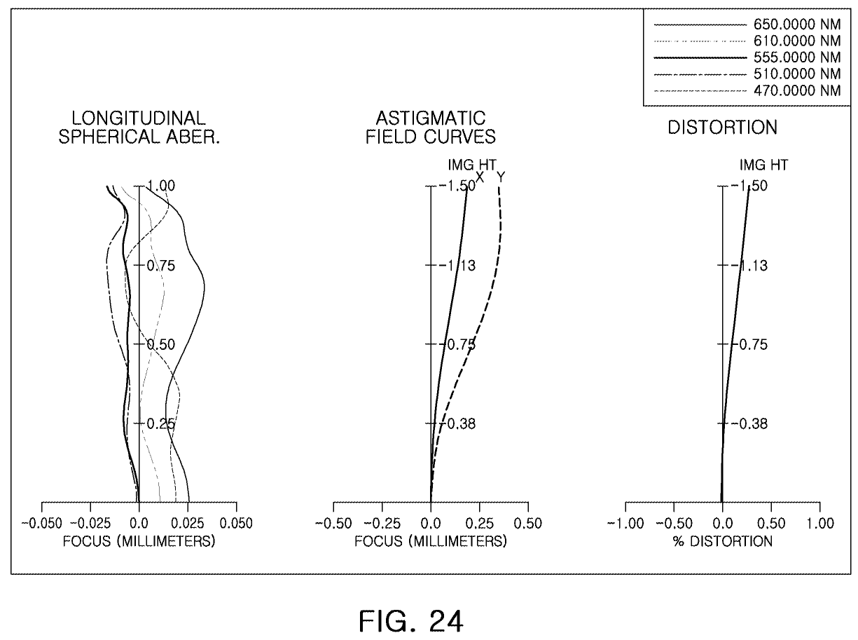

The optical imaging system 800 configured as described above may exhibit aberration characteristics of the form illustrated in FIG. 24. Tables 15 and 16 show lens characteristics and aspheric values of the imaging lens system according to the present embodiment.

Table 15

| Surfac e No. | Configuratio n | Radius of curvature | Thickness/di stance | Refractiv e index | Abbe’s No. | Focal length |
|---|---|---|---|---|---|---|
| S1 | First lens | 10.807 | 2.000 | 1.537 | 55.7 | 17.1673 |
| S2 | | -58.514 | 0.100 | | | |
| S3 | Second lens | 27.959 | 0.800 | 1.677 | 19.2 | -83.6514 |
| S4 | | 18.501 | 1.000 | | | |
| S5 | | Infinity | 0.000 | | | |
| S6 | First reflective portion | Infinity | 3.000 | 1.518 | 64.2 | |
| S7 | | Infinity | 3.000 | 1.518 | 64.2 | |
| S8 | | Infinity | 0.800 | | | |
| S9 | Third lens | 22.4705 | 0.400 | 1.646 | 23.5 | -127.8761 |
| S10 | | 31.081 | 0.100 | | | |
| S11 | Fourth lens | 57.5181 | 0.400 | 1.646 | 23.5 | -88.9736 |
| S12 | | Infinity | 0.200 | | | |
| S13 | Fifth lens | -19.2307 | 0.400 | 1.518 | 64.2 | -82.9800 |
| S14 | | -13.1942 | 0.400 | 1.518 | 64.2 | |
| S15 | Second reflective portion | Infinity | 4.400 | 1.518 | 64.2 | |
| S16 | | Infinity | 3.200 | | | |
| S17 | | Infinity | 1.600 | 1.518 | 64.2 | |
| S18 | | Infinity | 0.600 | 1.518 | 64.2 | |
| S19 | Third reflective portion | Infinity | 2.000 | 1.518 | 64.2 | |
| S20 | | Infinity | 4.000 | 1.518 | 64.2 | |
| S21 | | Infinity | 6.000 | | | |
| S22 | | Infinity | 3.500 | 1.518 | 64.2 | |
| S23 | | Infinity | 0.500 | | | |
| S24 | Filter | Infinity | 0.210 | | | |
| S25 | | Infinity | 1.556 | | | |
| S26 | Imaging plane | Infinity | 0.000 | | | |

Table 16

| Surfac e No. | S1 | S2 | S3 | S4 | S9 | S10 | S11 | S12 | S13 | S14 |
|---|---|---|---|---|---|---|---|---|---|---|
| K | 0 | 0 | 2.864E+01 | 1.462E+00 | 0 | 0 | 0 | 0 | 0 | 1.025E+01 |
| A | 0 | 0 | 3.436E-02 | 6.873E-03 | 0 | 0 | 0 | 0 | 0 | -5.507E-03 |
| B | 0 | 0 | -4.679E-03 | 4.923E-03 | 0 | 0 | 0 | 0 | 0 | 1.926E-03 |
| C | 0 | 0 | 1.442E-03 | 7.499E-07 | 0 | 0 | 0 | 0 | 0 | -2.913E-04 |
| D | 0 | 0 | 9.654E-04 | 8.854E-04 | 0 | 0 | 0 | 0 | 0 | -6.461E-05 |
| E | 0 | 0 | 4.035E-04 | 1.210E-03 | 0 | 0 | 0 | 0 | 0 | 1.122E-04 |
| F | 0 | 0 | -7.092E-04 | -6.263E-04 | 0 | 0 | 0 | 0 | 0 | 9.219E-05 |
| G | 0 | 0 | -2.294E-04 | 1.773E-04 | 0 | 0 | 0 | 0 | 0 | 6.168E-05 |
| H | 0 | 0 | 0 | 0 | 0 | 0 | 0 | 0 | 0 | 0 |
| J | 0 | 0 | 0 | 0 | 0 | 0 | 0 | 0 | 0 | 0 |

According to the embodiment described above, the imaging lens system may satisfy all of the conditional expressions mentioned above. Table 17 shows optical characteristic values and conditional expression values of the imaging lens systems according to the first to eighth embodiments.

Table 17

| Remark | First embodim ent | Second embodim ent | Third embodim ent | Fourth embodim ent | Fifth embodim ent | Sixth embodim ent | Seventh embodim ent | Eighth embodim ent |
|---|---|---|---|---|---|---|---|---|
| f | 24.8379 | 26.0002 | 26.0862 | 28.0032 | 19.1383 | 33.9955 | 34.3373 | 34.0000 |
| f number | 3.18 | 3.69 | 3.45 | 2.87 | 3.92 | 3.92 | 3.84 | 3.18 |
| TTL | 30.2842 | 31.1208 | 30.8560 | 37.0649 | 24.2809 | 40.2514 | 40.7917 | 40.1660 |
| BFL | 1.1136 | 1.1482 | 5.3834 | 0.6649 | 0.0000 | 1.3514 | 1.8917 | 1.7660 |
| V1-V2 | 33.5098 | 33.5098 | 32.1121 | 36.4792 | 36.4792 | 36.4792 | 36.4792 | 36.4792 |
| TTL/f | 1.2193 | 1.1969 | 1.1828 | 1.3236 | 1.2687 | 1.1840 | 1.1880 | 1.1814 |
| BFL/TTL | 0.8028 | 0.8241 | 0.8226 | 0.6735 | 0.7010 | 0.6845 | 0.6887 | 0.6963 |
| TTL/f1 | 3.1779 | 3.2398 | 3.0169 | 2.1712 | 2.3603 | 2.3483 | 2.3811 | 2.3397 |
| TTL/f2 | -4.1066 | -4.3864 | -4.3577 | -0.7587 | -0.7667 | -0.6267 | -0.7263 | -0.4802 |
| TTL/f3 | 1.5141 | 1.6729 | 1.9380 | -0.3274 | -0.7354 | -0.3440 | -0.1634 | -0.3141 |
| (f number*f) /TTL | 2.6081 | 3.0829 | 2.9167 | 2.1683 | 3.0898 | 3.3108 | 3.2324 | 2.6918 |
| Vh 1 /TTL | 0.2830 | 0.3044 | 0.2746 | 0.1862 | 0.1705 | 0.1714 | 0.1692 | 0.1718 |
| Vh2/TTL | 0.1954 | 0.2194 | 0.1888 | 0.1295 | 0.1186 | 0.1193 | 0.1177 | 0.1195 |

As set forth above, the optical imaging system, according to the present disclosure, may be mounted on a relatively small or thin terminal, while having a long focal length.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens group;
a first reflective portion comprising a plurality of reflective surfaces; and
a second reflective portion comprising a plurality of reflective surfaces,
wherein the first lens group, the first reflective portion, and the second reflective portion are sequentially arranged from an object side, and
2.0 < TTL/f1 < 4.0 is satisfied,
where TTL is a distance from an object-side surface of a first lens of the first lens group to an imaging plane, and f1 is a focal length of the first lens.

2. The imaging lens system of claim 1, wherein
the first reflective portion further comprises:
a first rearmost reflective surface disposed closest to the second reflective portion; and
a first reflective surface configured to re-reflect light reflected from the first rearmost reflective surface to the second reflective portion.

3. The imaging lens system of claim 2, wherein the first reflective portion further comprises a first frontmost reflective surface configured to reflect light exiting the first lens group to the first rearmost reflective surface.

4. The imaging lens system of claim 2, wherein
the second reflective portion further comprises:
a second frontmost reflective surface disposed closest to the first reflective portion; and
a second reflective surface configured to reflect light irradiated from the first reflective surface to the second frontmost reflective surface.

5. The imaging lens system of claim 4, wherein the second reflective portion further comprises a second rearmost reflective surface configured to reflect light irradiated from the second frontmost reflective surface to the imaging plane.

6. The imaging lens system of claim 4, wherein an included angle between the first rearmost reflective surface and the first reflective surface is equal to an included angle between the second frontmost reflective surface and the second reflective surface.

7. The imaging lens system of claim 1, wherein the first lens group has positive refractive power.

8. The imaging lens system of claim 1, further comprising a third reflective portion disposed on an object side of the first reflective portion.

9. The imaging lens system of claim 8, further comprising a second lens group disposed between the third reflective portion and the first reflective portion.

10. An imaging lens system comprising:
a lens group;
a first reflective portion comprising a plurality of reflective surfaces; and
a second reflective portion comprising a plurality of reflective surfaces, wherein
the first lens group, the first reflective portion, and the second reflective portion are sequentially arranged from an object side, and
the first reflective portion and the second reflective portion each include a total reflection surface.

11. The imaging lens system of claim 10, wherein
the lens group comprises:
a first lens having positive refractive power; and
a second lens having negative refractive power.

12. The imaging lens system of claim 11, wherein
30 < V1-V2 is satisfied,
where V1 is an Abbe number of the first lens, and V2 is the Abbe number of the second lens.

13. The imaging lens system of claim 11, wherein
2.0 < TTL/f1 < 4.0 is satisfied,
where TTL is a distance from an object-side surface of the first lens to an imaging plane, and f1 is a focal length of the first lens.

14. The imaging lens system of claim 11, wherein
-5.0 < TTL/f2 < -0.2 is satisfied,
where TTL is a distance from an object-side surface of the first lens to an imaging plane, and f2 is a focal length of the second lens.

15. The imaging lens system of claim 10, wherein
1.1 < TTL/f is satisfied,
where TTL is a distance from an object-side surface of a frontmost lens of the lens group to an imaging plane, and f is a focal length of the imaging lens system.

16. The imaging lens system of claim 10, wherein
0.6 < BFL/TTL < 0.9 is satisfied,
where BFL is a distance from an image-side surface of a rearmost lens of the lens group to an imaging plane, and TTL is a distance from an object-side surface of a frontmost lens of the lens group to an imaging plane.
